(19) United States
(12) Patent Application Publication
(10) Pub. No.: US 2020/0193337 A1
(43) Pub. Date: Jun. 18, 2020

(54) PROCESS ESTIMATION APPARATUS AND METHOD

(71) Applicant: CANON KABUSHIKI KAISHA, Tokyo (JP)

(72) Inventor: Keisuke Teranishi, Yokohama-shi (JP)

(21) Appl. No.: 16/716,906

(22) Filed: Dec. 17, 2019

(30) Foreign Application Priority Data
Dec. 17, 2018 (JP) 2018-235905

(51) Int. Cl. G06Q 10/06; G06Q 10/10; G06Q 50/00; H04W 4/02

(52) U.S. Cl. CPC G06Q 10/06; H04W 4/02; G06Q 50/00; G06Q 10/10

(57) ABSTRACT

A process estimation apparatus operable to, by machine learning using information regarding a plan as one of features, estimate a process being performed by a worker is provided. The apparatus comprises: a progress information accepting unit configured to accept progress information of each process configuring a plan that is generated in advance; an importance/urgency decision unit configured to decide an importance/urgency of each process that configures the plan that is generated in advance; and a calculation method decision unit configured to decide a method of calculating a feature related to a plan in accordance with the progress information accepted by the progress information accepting unit and the importance/urgency decided by the importance/urgency decision unit.

### BACKGROUND OF THE INVENTION

### Field of the Invention

The present invention relates to a process estimation apparatus and method for estimating a process performed by a worker.

### Description of the Related Art

Generally, when manufacturing a product, a plurality of types of work are performed. For example, in order to generate printed matter, it is necessary to perform work composed of a plurality of processes such as printing, binding, cutting, and inspection. Managing an estimate versus actual results has been widely performed by generating a work plan in advance based on the priority of each process and the deadline of printed matter, performing each process based on the plan, and then inputting the work results of each process. However, if the number of processes constituting the work increases or the amount of work increases, there is a problem that, because there is an increase in results that must be inputted, the load on a worker who inputs results increases.

If a process performed by a worker can be automatically estimated, the above-mentioned problem can be solved. For example, the position and orientation of a worker, the operation log of each apparatus, a prior plan, and the like are collected for each time and converted into features which are used, together with the work process actually performed by the worker (correct answer data) at each time, as training data for machine learning. By generating an estimator using the training data, it is possible to estimate when and what processes a worker has performed by giving the above-mentioned features to the estimator at an arbitrary time. Of the information available for estimation, information about the plan is particularly useful. This is because, when generating the plan, the worker commits to work on the basis of the plan. Unless special circumstances arise, it is considered highly likely that a process performed by the worker at each time is any process that is planned to be around that time. Even in the case where a delay occurs in the work and it becomes difficult to perform the work as planned in advance, by regenerating the best plan at the time of occurrence of the delay, it can be used as highly reliable information in an estimation technique.

For example, Japanese Patent Laid-Open No. 2005-78288 has a technique for using plan information for an estimation. Japanese Patent Laid-Open No. 2005-78288 proposes a method of estimating an actual position of a user using position information obtained from a single position positioning technique, and plan information. In this method, the priorities of various types of information are set in advance, and information having a high priority is used as an estimation result. That is, by raising the priority of plan information in advance, it is possible to output a result that takes into account the plan information at the time of estimation.

In addition, Japanese Patent Laid-Open No. 2007-306179 is a different example of using plan information in estimation. Japanese Patent Laid-Open No. 2007-306179 also proposes a method of using plan information for position estimation. In the method of Japanese Patent Laid-Open No. 2007-306179, a system side determines a method for using plan information in consideration of the certainty of a plan, and then performs position estimation.

In general, in an estimation technique that uses plan information, whether or not accurate plans can be gathered is important because it has a large influence on an estimation accuracy that uses the plans. Therefore, if a delay occurs due to a sudden event such as a failure of an apparatus, and it becomes difficult to perform work as planned in advance, it is desirable to regenerate the plan at that point and ensure the accuracy of the plan information.

### SUMMARY OF THE INVENTION

However, in an actual manufacturing site, when it becomes impossible to perform work as planned in advance, planning is not necessarily performed again. If processing steps for planning again as a work flow at a site have not been converted into rules, each worker may respond without planning again at their discretion. For example, if a delay has occurred in a plan, a person in charge of the work determines and copes on their own with how to proceed with the subsequent work, depending on the level of delay and how high the urgency or the importance of the delayed process is in the overall plan. If the importance/urgency of the delayed process is low and does not affect other work plans, there is a strong tendency for the work to continue with the scheduled work time period in the order of work processes scheduled in the prior plan. On the other hand, in a situation where the urgency or importance of a delayed process in the overall plan is high and the delayed situation affects the delivery deadline of the manufacturing, there is a strong tendency to cope by working in a shorter amount of time than planned in any process. Even in the above-described example, if there is explicit replanning, information on actions that a worker can take is included as reliable information in the plan information. Therefore, even in a case where the actions that a worker can take differ depending on the circumstances of the site as described above, accurate estimation can be expected by using the plan information as one piece of information used by an estimator. However, it is difficult to accurately estimate without planning again.

In the method described in Japanese Patent Laid-Open No. 2005-78288, it is necessary to decide in advance which information should be prioritized when estimating. Therefore, when it is set that plan information is preferentially used, the estimation accuracy is lowered in a situation where the plan is not correct. Since whether or not a plan is correctly maintained by performing planning again when a delay occurs differs depending on the user, the above-mentioned problem cannot be solved.

In Japanese Patent Laid-Open No. 2007-306179, the system side determines how to use the plan information in consideration of the certainty of the plan, but countermeasures in the case where the certainty of the plan is low are uniform. Therefore, it is not appropriate to apply this system to events in which the content of the work differs depending on the situation as described above. In particular, the prior art cannot deal with manufacturing sites in which action in response to delay of plan varies depending on the degree of importance and/or urgency of delayed work (whether or not they are included in a pre-created critical path in a plan, whether or not the critical path has enough margin or is about to reach its turnaround).

That is, in the conventional technique, when planning is not performed again in a situation where work is not proceeding as planned, plan information cannot be handled appropriately in order to estimate a process performed by a worker. It should be noted that it is theoretically possible to use a machine learning algorithm that considers the weight of each feature to train weighting for when a delay occurs due to a sudden matter. However, as a problem in actual operation of such an algorithm, it is difficult to generate an appropriate estimation model unless sufficient data for training is collected.

Certain embodiments of the present invention provide a technique capable of appropriately creating a feature related to a plan used in process estimation by machine learning without re-planning even in a situation where work is not proceeding as planned in advance.

As a means for solving the above problems, a process estimation apparatus according to an embodiment of the present invention has the following configuration.

A process estimation apparatus operable to, by machine learning using information regarding a plan as one of features, estimate a process being performed by a worker, the apparatus comprising: a progress information accepting unit configured to accept progress information of each process configuring a plan that is generated in advance; an importance/urgency decision unit configured to decide an importance/urgency of each process that configures the plan that is generated in advance; and a calculation method decision unit configured to decide a method of calculating a feature related to a plan in accordance with the progress information accepted by the progress information accepting unit and the importance/urgency decided by the importance/urgency decision unit.

By virtue of embodiments of the present invention, it is possible to appropriately create a feature related to a plan used in process estimation by machine learning without re-planning even in a situation where work is not proceeding as planned in advance. Accordingly, the accuracy of the process estimation can be improved.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a diagram illustrating an example of a configuration of a process estimation system.

FIG. 2 is a diagram illustrating an example of a configuration of a process estimation apparatus.

FIGS. 3A, 3B, 3C, and 3D are diagrams illustrating an example of a configuration of tables for storing details of work definition information.

FIGS. 4A and 4B are views illustrating examples of the configuration of tables that store details of an order and a plan.

FIG. 5 is a diagram illustrating functions of a process estimation apparatus according to a first embodiment.

FIG. 6 is a diagram illustrating an example of the configuration of a table for holding data relating to features.

FIG. 7 is a diagram illustrating a concept of features relating to a plan.

FIGS. 8A, 8B, and 8C are diagrams illustrating an example of a configuration of a table for holding distribution patterns used when calculating feature values related to a plan, in the first embodiment.

FIGS. 9A and 9B are diagrams illustrating processing flow for deciding a method of calculating a feature value related to a plan.

FIGS. 10A and 10B are diagrams illustrating a processing flow for generating a virtual plan in the first embodiment.

FIGS. 11A, 11B, and 11C are diagrams illustrating a processing flow for generating a distribution used when calculating feature values related to a plan, in the first embodiment.

FIGS. 12A and 12B are diagrams illustrating examples of plans envisioned when the process estimation apparatus calculates a feature value related to a plan (when a process which is on a critical path is delayed and when a process which is not on a critical path is delayed).

FIGS. 13A, 13B, and 13C are diagrams illustrating a concept of a feature relating to the plan in the case where a computer and a human are not sharing a plan.

FIGS. 14A and 14B are diagrams illustrating an example of plans envisioned when the process estimation apparatus calculates the feature value related to a plan (when the work is earlier than the plan and when the work is performed in a different order than in the plan).

FIG. 15 is a view illustrating an example of a configuration of a table for storing distribution patterns used when calculating feature values related to a plan, in a second embodiment.

FIG. 16 is a view illustrating an example of a configuration of a table for storing virtual plan patterns used when generating a virtual plan, in the second embodiment.

FIG. 17 is a diagram illustrating a function of a process estimation apparatus according to a third embodiment.

FIG. 18 is a view illustrating an example of a screen displayed by the process estimation apparatus.

FIG. 19 is a view illustrating an example of a screen displayed by the process estimation apparatus.

FIG. 20 is a view illustrating an example of a screen displayed by the process estimation apparatus.

FIG. 21 is a view illustrating an example of a screen displayed by the process estimation apparatus.

FIG. 22 is a view illustrating an example of a screen displayed by the process estimation apparatus.

### DESCRIPTION OF THE EMBODIMENTS

Below, with reference to the attached drawings, a detailed explanation is given for the present invention based on preferred embodiments. Note that the configurations described in the following embodiments are merely examples, and the present invention is not limited to the illustrated configuration. In addition, the same or equivalent components, members, and processing illustrated in the respective drawings are denoted by the same reference numerals, and duplicate descriptions are omitted as appropriate. In the drawings, some members which are not important for explanation are omitted.

### First Embodiment

A proposed process estimation apparatus is constructed at a site where a product is produced by a person or an apparatus based on a plan. In the following description, a printing factory is taken as an example, but there is no limitation to this, and construction may be performed at other production sites.

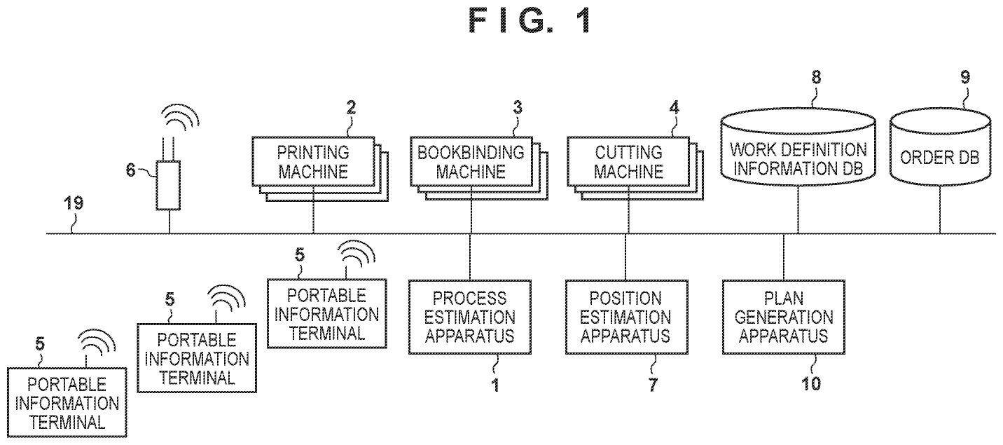

FIG. 1 illustrates a block diagram of a process estimation system. The process estimation apparatus 1 is an apparatus for collecting data obtained from a printing factory such as an operation log of a machine operating in the printing factory, information on an operation of a worker, and information on a plan, and estimating work processes being performed at a printing site. Printing machines 2 are machines for printing on a sheet. Bookbinding machines 3 are machines for binding printed sheets. Cutting machines 4 are machines for cutting sheets. Portable information terminals 5 refer to a terminal that can be carried by a user, such as a mobile phone, a PHS, or a notebook PC, and can communicate via a wireless LAN or the like. The portable terminals 5 have inside a sensor for measuring acceleration, angular acceleration, geomagnetism, and the like. In addition, the portable terminal 5 can transmit measured sensor information together with time information to the process estimation apparatus 1 and a position estimation apparatus 7 via a wireless access point 6. The position estimation apparatus 7 is an apparatus that estimates the position of users who possess the portable terminals 5 from sensor information received from the portable terminals 5. A work definition information DB 8 is a DB (database) that stores information used when a work resource (a worker or a machine) in a printing site generates a plan to be followed. An order DB 9 is a DB for managing orders received by the printing factory. A plan generation apparatus 10 is an apparatus that uses the work definition information DB 8 to generate a plan that is followed by the work resources of the printing site. The previously-described apparatuses 1, 7, 10, machines 2, 3, 4, DB 8 9, and access point 6 are communicably connected to each other by a local area network 19.

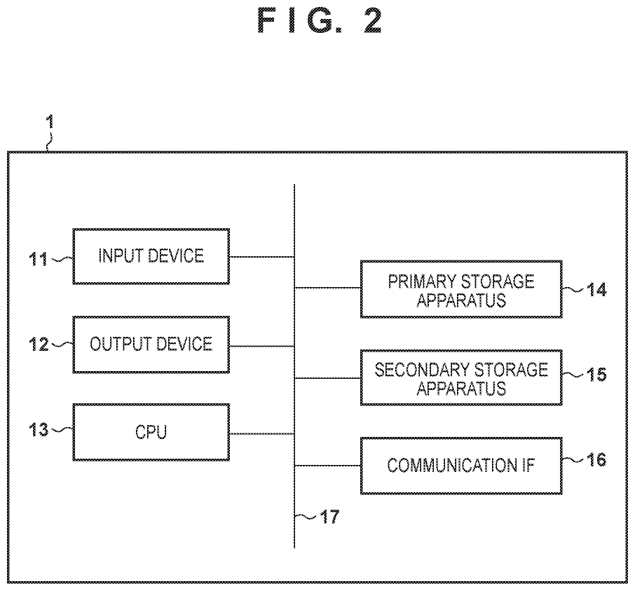

FIG. 2 illustrates a specific configuration diagram of the process estimation apparatus 1. An input device 11 is a mouse, a digitizer, or the like, and is used for inputting a user instruction to the process estimation apparatus 1. An output device 12 may be a light emitting diode (LED) or a liquid crystal display for displaying the state of the apparatus or the details of processing. A CPU (central processing unit) 13 reads a program stored in a secondary storage apparatus 15 into a primary storage apparatus 14. Further, the CPU 13 interprets and executes the read program to display a UI (User Interface) or perform various controls or calculates in the apparatus. The primary storage apparatus 14 is predominantly a memory such as a RAM (Random Access Memory). The secondary storage apparatus 15 stores a process estimation program necessary for causing the process estimation apparatus 1 to operate. The secondary storage apparatus 15 corresponds to a storage medium such as a hard disk or a flash memory, but it is needless to say that the present invention does not depend on a specific storage medium. Generally, the capacity of the primary storage apparatus 14 is smaller than the capacity of the secondary storage apparatus 15, and programs, data, and the like which cannot be stored in the primary storage apparatus 14 are stored in the secondary storage apparatus 15. In addition, data and the like which must be stored for a long time is also stored in the secondary storage apparatus 15. A communication IF (interface) 16 is connected to the local area network 19, and is for a time of communicating with various apparatuses/machines/DBs/access points/portable terminals 2 to 9 in the factory. Reference numeral 17 denotes a bus for communicably connecting the constituent elements 11 to 16 to one another.

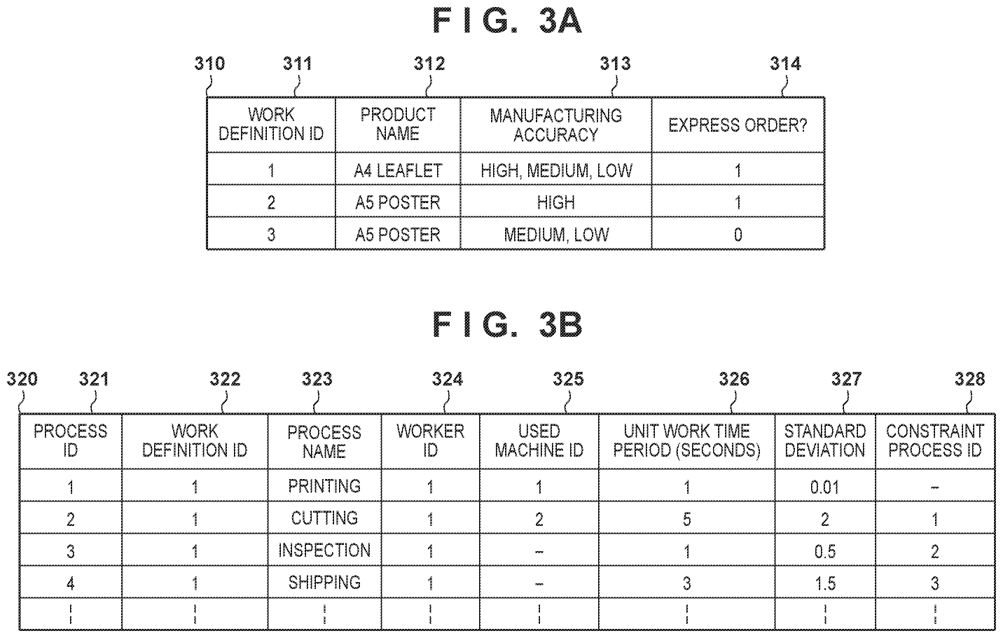

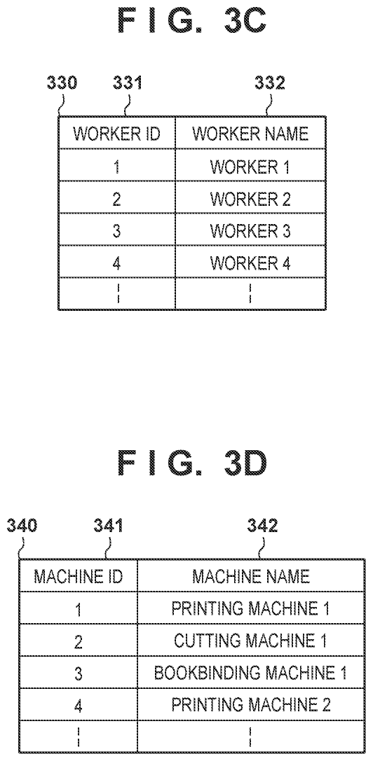

FIGS. 3A, 3B, 3C, and 3D illustrates an example of a storage format of work definition information managed by the work definition information DB 8. Work definition information includes a process required to produce a specific product, a unit work time period thereof, a worker in charge of the process, and a resource to be used.

FIG. 3A illustrates a work definition information table 310 for managing work definition information. A column 311 stores information of work definition information IDs for uniquely identifying each piece of work definition information. A column 312 stores product type information indicating which product is to be manufactured in accordance with each piece of work definition information. A column 313 stores information on manufacturing accuracy as an attribute item. Manufacturing accuracy is information on a level of accuracy with which a product is manufactured when manufacturing the product. When generating a plan, the plan is generated using work definition information having a manufacturing accuracy specified by a customer as an attribute value. In the examples of FIG. 3A, manufacturing accuracy of three levels—high, medium, and low—is illustrated, but there is no limitation to this. For example, it may be expressed by inputting a numerical value representing the accuracy. A column 314 stores information on whether this is for an express order as an attribute item. Whether or not an order is an express order is information indicating whether or not an interval from the date of order reception until a deadline date is short. In the example of FIG. 3A, when “1” is inputted, it indicates that this is work definition information for processing an express order. When “0” is inputted, it indicates that this is work definition information for processing an order that is not an express order. When content of work definition information for processing an express order and content of work definition information for processing an order that is not an express order are the same, a value such as “1, 0” may be stored in the column 314 and shared. When generating a plan, in a case where an order as an express order is received, work definition information is generated using work definition information in which 1 has been inputted for the express order attribute. In the example of FIG. 3A, whether or not an order is an express order is represented by binary values of 0 and 1, but there is no limitation to this. For example, the number of days from the order reception date to the deadline date, or a range of a number of days may be indicated as the attribute value. In addition, although two pieces of information are illustrated as attribute items here, there is no limitation to two, and attributes may be added as necessary. The attribute items to be added include, for example, information indicating whether or not the process is important and whether or not the process is urgent.

FIG. 3B illustrates a process table 320 for managing processes required for manufacturing products. A column 321 stores information of process IDs for uniquely identifying each process. A column 322 stores a work definition information ID indicating which work definition information is associated with the process. The work definition information ID in the column 322 corresponds to the work definition information ID in the column 321 of FIG. 3A. A column 323 stores information on the type of the process, which indicates information as to what work process this is. A column 324 stores information about a worker who performs the process. The information stored in the column 324 refers to a table 330 of FIG. 3C, which will be described later. A column 325 stores information indicating what machine is used to perform the process. Note that the information stored in the column 325 refers to a table 340 of FIG. 3D, which will be described later. A column 326 stores a unit work time period of each process. When a work plan is generated, the amount of time required for each process is calculated using information on the unit work time period and information on the number of copies ordered, which will be described later. The column 326 stores standard deviation information as information on the variation of the unit work time period 326. A column 328 stores information of constraint conditions between respective processes. In the example of FIG. 3B, it is indicated that unless the cutting with the process ID of 2 is completed, the inspection with the process ID of 3 is not performed.

FIG. 3C illustrates the table 330 for managing information of workers who work at a printing site. A column 331 stores information of worker IDs for uniquely identifying each worker. A column 332 stores information on the name of each worker, and is displayed on a screen that displays plan information.

FIG. 3D illustrates the table 340 for managing information of machines that operate at the printing site. A column 341 stores information of machine IDs for uniquely identifying each machine. A column 342 stores information on the name of each machine, and is displayed on a screen that displays plan information. Note that the format of the data is not relevant as long as there is information equivalent to that of the tables 310 to 340. For example, the data may be converted into a format defined by XML or the like and stored.

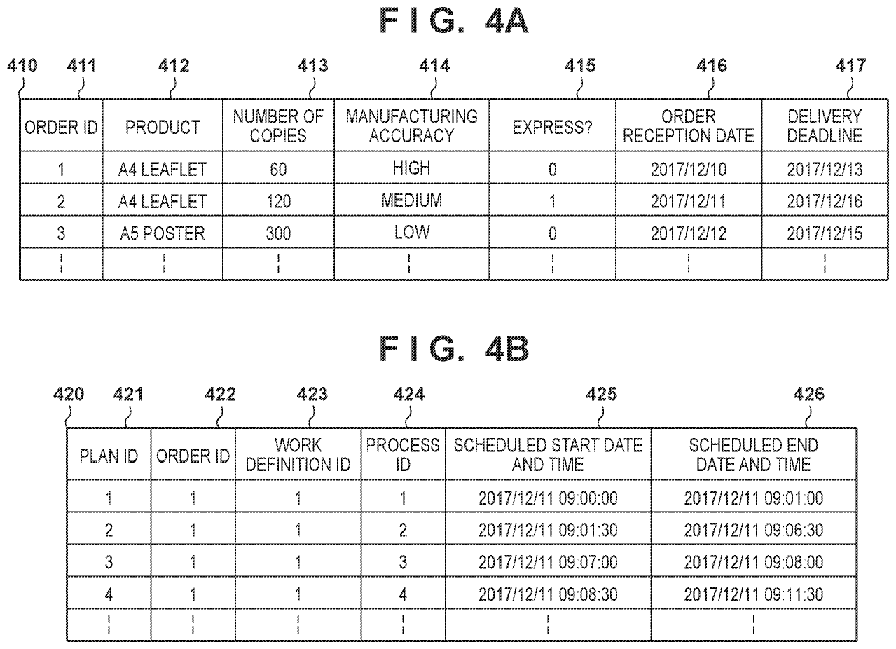

FIGS. 4A and 4B illustrates an example of orders received from a customer and a storage format of a manufacturing plan generated after receiving the order. Information about an order is stored in the order DB 9. Information on a plan is generated by the plan generation apparatus 10, and the generated plan information is transmitted to the process estimation apparatus 1.

FIG. 4A illustrates an order table 410 for managing information of orders received from customers. A column 411 stores order IDs for uniquely identifying each order. A column 412 stores information indicating a type of an ordered product. A column 413 stores a number of copies, which is information on a quantity for the order received. For example, when the product to be produced is a leaflet, the number of orders is the number of leaflets, and when the product to be produced is a booklet, the number of orders is the number of booklets to be shipped as a booklet. A column 414 stores information on an accuracy required when manufacturing the product. A column 415 store information on whether the order is an express order. A column 416 stores date information for when the order was received. A column 417 stores information of delivery deadlines for respective orders.

FIG. 4B illustrates a plan table 420 for managing the plan information of when the respective processes are performed. A column 421 stores plan IDs for uniquely identifying each plan. A column 422 stores information of an order ID for specifying which order is to be processed for this process. Note that the information stored in the column 422 refers to the table 410 of FIG. 4A. A column 423 stores work definition IDs for specifying which work definition information was used to perform planning. Note that the information stored in the column 422 refers to the table 310 of FIG. 3A. A column 424 stores process IDs for specifying which process was used to perform planning. Note that the information stored in the column 424 refers to the table 320 of FIG. 3B. A column 425 stores date and time information that is scheduled for the start of the work. A column 426 stores date and time information that is scheduled for the end of the work. Note that the format of the data is not relevant as long as there is information equivalent to that of the tables 410 and 420. For example, the data may be converted into a format defined by XML or the like and stored.

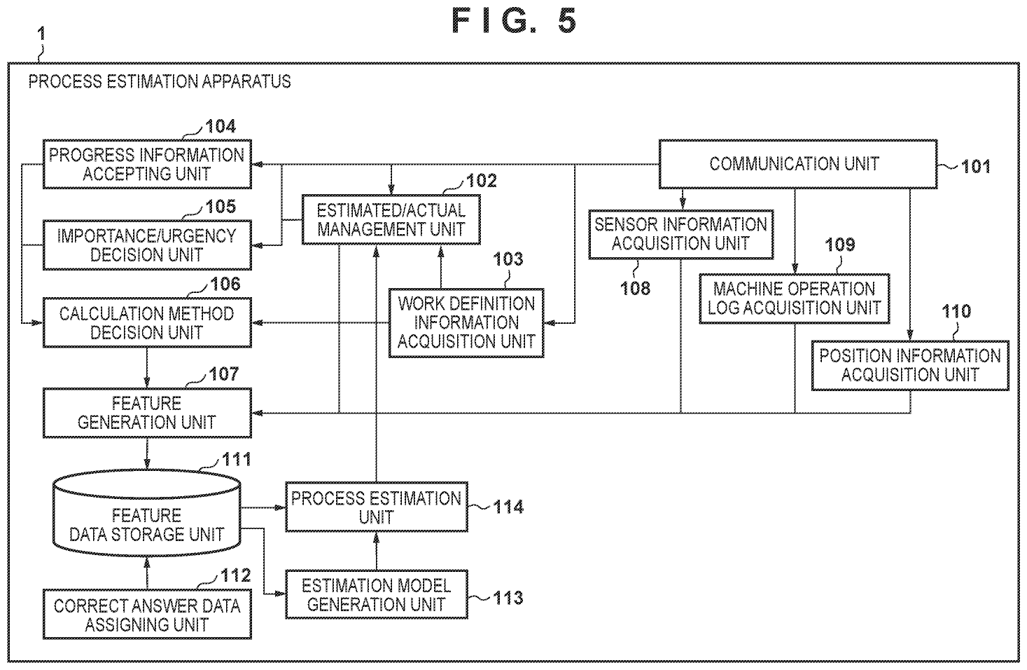

FIG. 5 illustrates a functional block diagram for explaining the main functions of the process estimation apparatus 1 according to the present embodiment. Each block illustrated here can be realized in hardware by an element such as a CPU of a computer or a mechanical apparatus, and is realized in software by a computer program or the like, but here, functional blocks realized by cooperation of these elements are depicted. As such, a person having ordinary skill in the art who came into contact with this present specification would understand that these functional blocks may be implemented in a variety of forms by a combination of hardware and software.

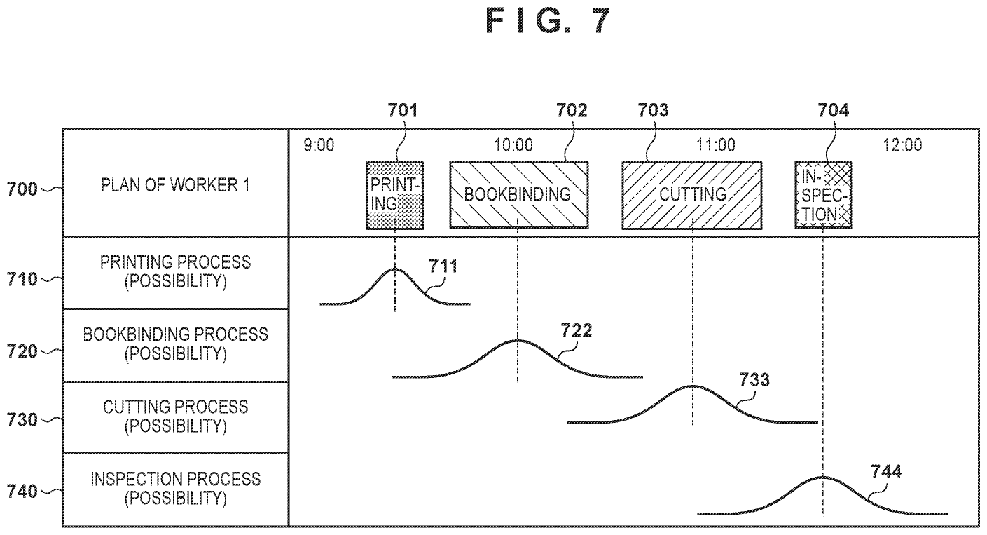

A communication unit 101 functions for other functional blocks of the process estimation apparatus 1 to perform data communication with an apparatus/machine/DB/access point in a factory which are to be connected to via the local area network 19. An estimated/actual management unit 102 receives and manages the plan information generated by the plan generation apparatus 10. More specifically, the order table 410 and the plan table 420 are received and held in the process estimation apparatus 1. In addition, the estimated/actual management unit 102 manages estimation results of processes performed at respective times that are estimated by the process estimation unit 114, which will be described later, in association with the plan information as the actual result information for the plan information. A work definition information acquisition unit 103 acquires information on a work definition from the work definition information DB 8, and provides this information to other functions in the process estimation apparatus 1. Specifically, information of the work definition information table 310, the process table 320, the worker table 330, and the machine table 340 is acquired. A progress information accepting unit 104 receives progress information of work with respect to a plan at a printing site from an external apparatus/system, the estimated/actual management unit 102, or the input device 11 of the process estimation apparatus 1. An importance/urgency decision unit 105 decides the importance or urgency of a process for which work is scheduled based on information held by the estimated/actual management unit 102 or information received from the input device 11 of the process estimation apparatus 1. A calculation method decision unit 106 decides a method of calculating a feature value relating to a plan which is to be used in machine learning or deep learning. At this time, information of the work definition information, a work progress degree, and the importance/urgency of a process for which work is scheduled is received from the work definition information acquisition unit 103, the progress information accepting unit 104, and the importance/urgency decision unit 105, and the calculation method is decided based on these pieces of information. A feature that relates to a plan is expressed by the magnitude of the possibility of each estimation candidate process being a correct answer, which is calculated based on the plan information. A specific procedure for deciding a calculation method will be described later with reference to FIG. 7 to FIGS. 11A, 11B, and 11C.

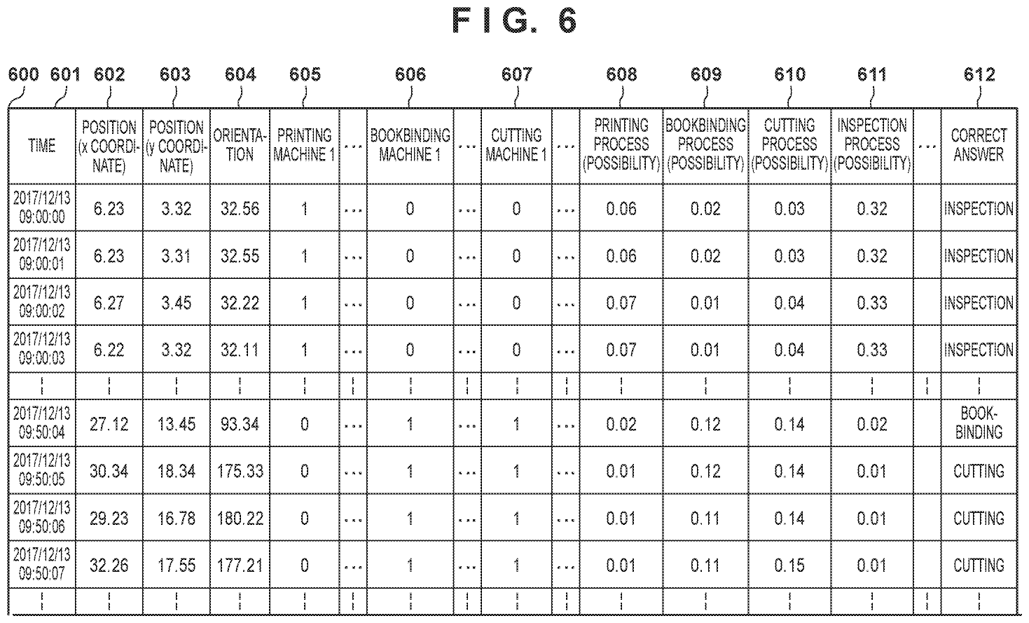

A sensor information acquisition unit 108 receives measurement results of various sensors that perform measurement on the portable information terminal 5, and user information of the portable terminal. A machine operation log acquisition unit 109 acquires operation logs from machines such as the printing machine 2, the bookbinding machine 3, and the cutting machine 4 that operate in the factory. A position information acquisition unit 110 acquires position information of the portable information terminals 5 that are estimated by the position estimation apparatus 7. Since the portable information terminals are held by workers working in the printing factory, the position information of the workers is acquired. The feature generation unit 107 receives various data from the estimated/actual management unit 102, the sensor information acquisition unit 108, the machine operation log acquisition unit 109, and the position information acquisition unit 110, and generates features used in machine learning and deep learning. Note that a method decided by the calculation method decision unit 106 is followed when generating a feature related to the plan. An overview of a feature generated by the feature generation unit 107 and the procedure for generating the feature will be described later with reference to FIG. 6 and FIG. 7.

A feature data storage unit 111 stores data of a feature generated by the feature generation unit 107. To features for each time generated by the feature generation unit 107, the correct answer data assigning unit 112 assigns, as correct answer data for machine learning, a process actually performed at the printing site at each time. The estimation model generation unit 113 generates an estimator for process estimation by taking, as training data, the features to which correct answer data has assigned by the correct answer data assigning unit 112. The process estimation unit 114 uses the estimator generated by the estimation model generation unit 113 to estimate, with respect to a feature for any time for which correct answer data stored by the feature data storage unit 111 has not been assigned, a work process that was performed at that time. In addition, the process estimation unit 114 transmits an estimation result to the estimated/actual management unit 102.

FIG. 6 illustrates a feature table 600 stored in the feature data storage unit 111. Each row of the feature table 600 holds data relating to the printing factory at each time. The feature table 600 is generated for each estimation target. The feature table 600 is used to train the above-mentioned estimator. The feature table 600 is also input data for when the generated estimator estimates the type of a process that an estimation target was performing at an arbitrary time.

A column 601 stores time information for specifying which time data each row of the feature table 600 corresponds to. The information stored in a column 602 and a column 603 expresses, as information on a plane, where the portable information terminals 5 are located in the printing factory, and indicates an x coordinate and a y coordinate in the printing factory, respectively. The information of the columns 602 and 603 is generated by the feature generation unit 107 based on the position information, estimated by the position estimation apparatus 1, of the portable information terminals 5 at each time. Information stored in a column 604 represents, as information on a plane, a direction in which the portable information terminals 5 face, and indicates a value between 1 and 360 (unit: degrees). The information stored in the column 604 is generated by the feature generation unit 107 based on information, which is acquired by the sensor information acquisition unit 108, on a direction at each time point from the portable information terminals 5. Although features relating to the position and orientation is provided in the feature table 600 as information in a plane, that is, two-dimensional information, it may be provided as stereoscopic information, that is, three-dimensional information. Information as to whether or not the printing machine 2, the bookbinding machine 3, and the cutting machine 4 are operating is stored in a column 605, a column 606, and a column 607, respectively. Specifically, a value of 0 when a machine is operating and a value of 1 when the machine is not operating is stored as a feature. Though omitted in FIG. 6, the table 600 also includes operating conditions relating to other machines operating in the printing factory. The features relating to the above-mentioned machines stored in the columns 605 to 607 are generated by the feature generation unit 107 based on the information relating to a machine's operation log which is acquired by the machine operation log acquisition unit 109.

A column 608 stores a value representing a possibility that the estimation target is performing the printing process at each time. Similarly, the columns 609, 610, and 611 store values representing the possibility that the estimation target is performing a bookbinding process, a cutting process, and an inspection process, respectively. Though omitted in FIG. 6, values representing the possibility that the process is being performed in relation to other processes are also written in an independent column constituting the feature table 600. The feature generation unit 107 generates a feature representing the possibility of each process being performed by using the information held by the estimated/actual management unit 102. A concrete method of deciding a value expressing the possibility of each process being performed will be described later with reference to FIG. 7. In a column 612, the work process actually performed by the estimation target at each time is stored as correct answer data for machine learning. The assignment of correct answer data is explicitly performed by a user via the input device 11, and implemented as a function of the correct answer data assigning unit 112.

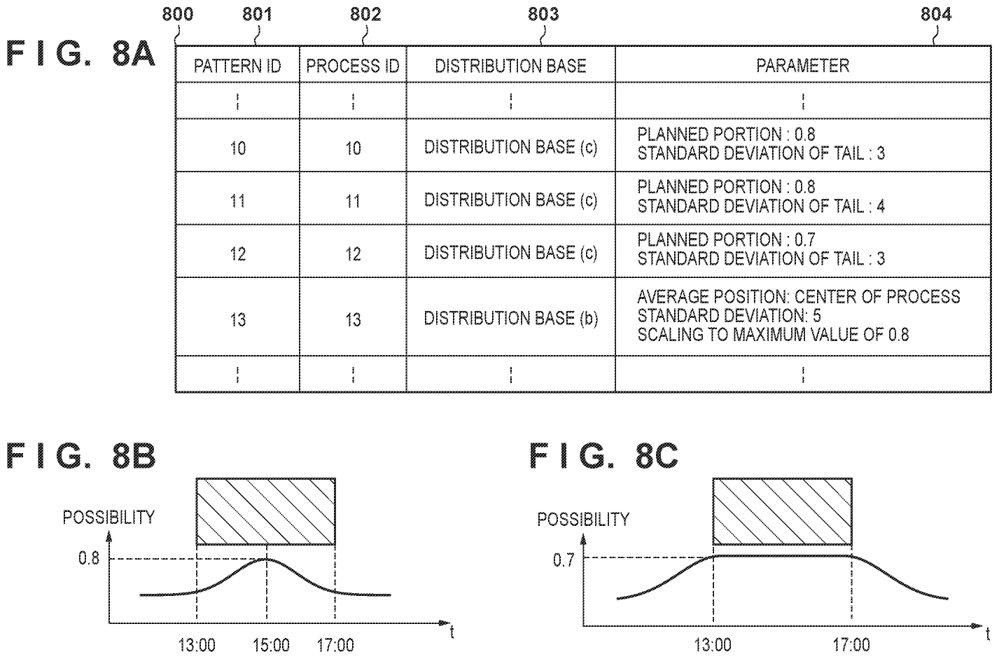

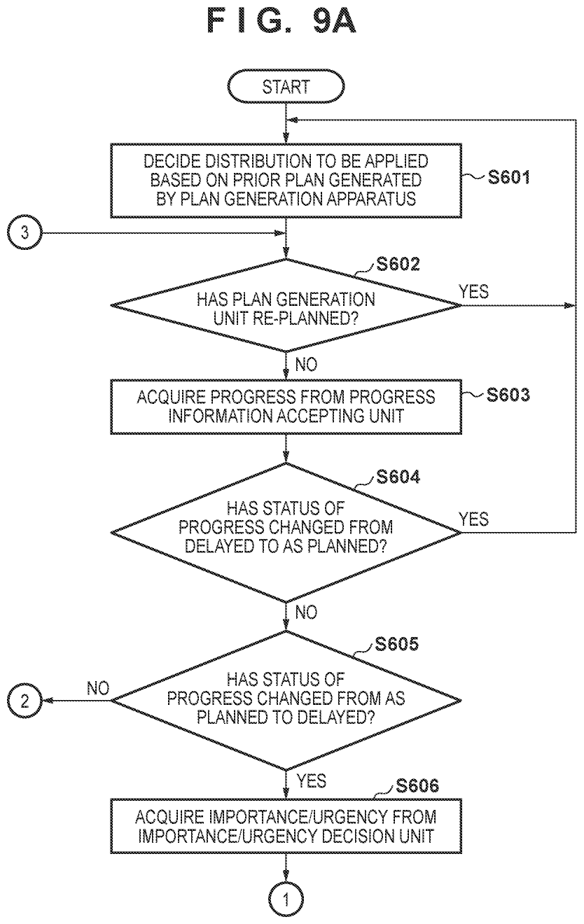

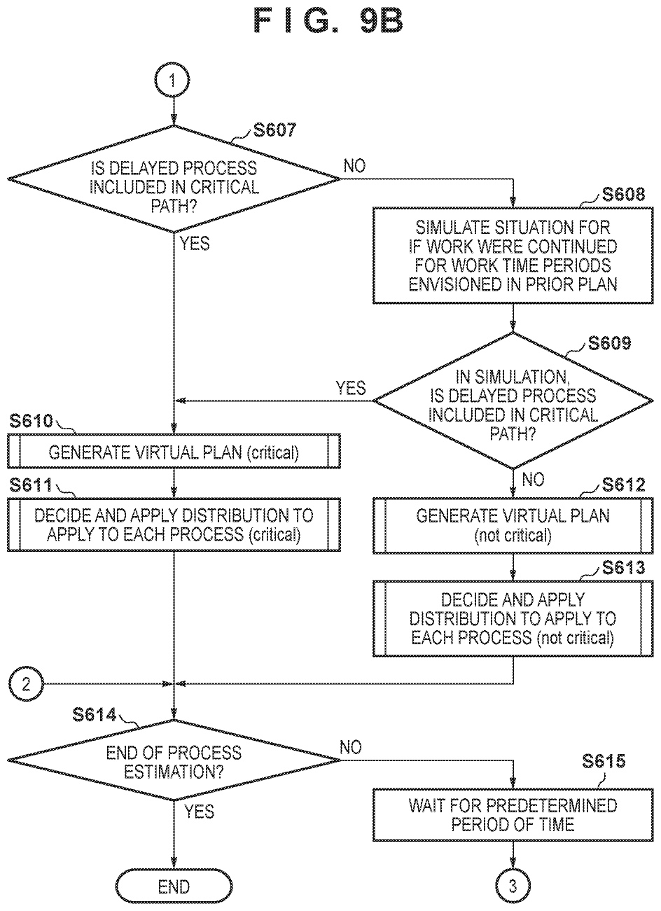

Using FIG. 7 and FIGS. 8A, 8B, and 8C, description will be given for an overview of a method of calculating values representing the magnitude of the possibility that respective processes are being performed, which are stored in the columns 608 to 611 of the feature table 600. A more detailed calculation method will be described later with reference to FIGS. 9A and 9B, FIGS. 10A and 10B, and FIGS. 11A, 11B, and 11C.

FIG. 7 is a diagram illustrating a concept of features relating to a plan. A row 700 in FIG. 7 illustrates the work plan of a worker 1 in time series. The worker 1 is scheduled to perform a printing process 701, a bookbinding process 702, a cutting process 703, and an inspection process 704 in a time band of 9:00 to 12:00. A row 710 in FIG. 7 illustrates the possibility that the worker 1 is performing the printing process at each time in accordance with a distribution 711 with respect to the time axis. Similarly, in the rows 720, 730, and 740 of FIG. 7, the distributions 722, 733, and 744 respectively illustrate the possibility that the worker 1 is performing the bookbinding process, the cutting process, and the inspection process. That is, the height of a distribution at each time becomes the possibility that the process linked to the distribution is being performed. The plan in the row 700 indicates when the worker 1 is scheduled to perform which process, and the worker 1 performs the work based on the plan. Thus, the possibility that a particular process is being performed at each time is correlated to how far apart each time is from a time band in which the process is scheduled to be performed in row 700. The distributions 711 to 744 are distributions generated so as to reflect the degree of correlation.

The distributions 711 to 744 are generated based on information of a distribution pattern definition table 800 illustrated in FIG. 8A. A column 801 stores IDs for uniquely identifying distribution patterns. A column 802 stores process IDs. The process IDs refers to process IDs in the column 321 of the process table 320. A column 803 stores information serving as a base of a distribution to be finally generated (hereinafter referred to as a distribution base). Specifically, information representing an approximate form of a distribution is stored: for example, information representing a type of distribution for specifying a basic property of the distribution, such as a normal distribution, a Poisson distribution, or the like, is stored. Information specifying the detailed properties of the distribution, for example, how much variation the distribution of the type illustrated in column 803 has, is stored in a column 804. The column 804 stores various parameters necessary when actually generating a distribution using the distribution base defined in the column 803. For example, when the distribution base of the column 803 is a normal distribution, the column 804 stores, for example, information corresponding to the average and the degree of variation of the distribution. For the process in the row 700 corresponding to the process ID in column 802, the distribution base and parameters stored in columns 803 and 804 are applied.

The distribution base (b), the procedure for generating the distribution base (b), the distribution base (c) and the procedure for generating the distribution base (c) in the present embodiment will be described with reference to FIG. 8B and FIG. 8C, respectively, taking the case where the pattern IDs are 13 and 12 as examples.

In an embodiment, the distribution base (b) is a normal distribution. The box in FIG. 8B illustrates that a process having the process ID of 13 is scheduled to be carried out from 13:00 to 17:00. The distribution illustrated in FIG. 8B is a distribution indicating the magnitude of the possibility that the process having the process ID of 13 is performed. First, with respect to the time band (13:00 to 17:00) of the box, a normal distribution is generated in which the center (15:00) of the time band becomes the average value and the standard deviation is 5. Thereafter, a scaling process is performed on the entire distribution so that the maximum value of the distribution becomes 0.8. Information indicating that the center of the distribution is the center of the plan, the standard deviation is 5, and the maximum value of the distribution is 0.8 is acquired from the column 804. In the example of FIG. 8B, the possibility that the process is being performed at 15:00 is 0.8, and the features are generated so that the possibility gradually becomes smaller in preceding and succeeding time bands.

On the other hand, in the present embodiment, the distribution base (c) is a distribution in which a portion of the first half monotonically increases, an intermediate portion is a constant value, and a portion of the second half monotonically decreases. The box in FIG. 8C illustrates that a process having the process ID of 12 is scheduled to be carried out from 13:00 to 17:00. In the distribution illustrated in FIG. 8C, the magnitude of the distribution is uniformly 0.7 in the time band (13:00 to 17:00) in which the process with the process ID of 12 is planned. In the time band before 13:00, the magnitude gradually decreases from 0.7 as the amount of time from 13:00 increases. In the time band after 17:00, the magnitude gradually decreases from 0.7 as the amount of time from 17:00 increases.

Description will be given of a specific method of deciding the distribution of the portions before 13:00 and after 17:00 (hereinafter, each may be represented as a “tail of the distribution” or a “tail portion”). As written in the column 804 of the table 800, the standard deviation of the tail having the pattern ID of 12 is 3. Therefore, first, a normal distribution having an average of 0 and a standard deviation of 3 is generated, and scaling is performed so that the maximum value of the generated normal distribution becomes 0.7 for the planned portion. For where the distribution after scaling is less than or equal to 0, the distribution of the part before 13:00 in FIG. 8C is adopted. In such a case, the position at which the maximum value after scaling is obtained is aligned with the position for 13:00 in FIG. 8C. Similarly, for where the distribution after scaling is greater than or equal to 0, the distribution of the part after 17:00 in FIG. 8C is adopted. In such a case, the position at which the maximum value after scaling is obtained is aligned with the position for 17:00 in FIG. 8C.

Description will be given for handling in the case where a plurality of processes of the same type are scheduled in the row 700. Firstly, a distribution is generated by the above-described procedure for each process scheduled at each location. In this case, at each time, there are as many values representing the magnitude of the possibility of a process as the number of distributions. In the present embodiment, the total of the values of the possibilities from the respective distributions at each time is defined as the magnitude of the possibility at that time. Note that the magnitude of the possibility at each time may be defined by another method. Configuration may be taken to, at each time, calculate, from only the distribution generated from the nearest scheduled process, the magnitude of the possibility of that process at that time.

Note that distributions other than those described above may be base distributions. For example, a Poisson distribution, a distribution defined by a non-parametric method, or any other generally defined distribution may be used. Further, in the example of FIGS. 8A, 8B, and 8C, the case where an average position is the center of the scheduled time band of the process has been described as an example of a parameter of the distribution pattern (b), but the center may be the starting time or the ending time of the scheduled time band. Furthermore, the spread of distribution of the distribution pattern (c) may be shaped according to the planned length of time. Although the distribution pattern is defined for each process ID in the present embodiment, the distribution pattern may be defined using other attributes.

The process estimation unit 114 according to the present invention estimates the type of the process at each time by using a trained estimation model in machine learning. Description will be given regarding generation of an estimation model in machine learning using the feature table 600 described above, the accuracy of the generated estimation model, and actual estimation using the estimation model. It is a first object of the process estimation unit of the present invention to estimate, in real time, a process being performed by an estimation target. However, the content described in the present invention is also applicable to non-real-time estimation.

First, a procedure for generating an estimation model will be described. In order to generate the estimation model, feature data obtained by digitizing features included in various data collected from the printing site is generated for each time. With respect to the generated feature data for each time, the type of a process actually performed by a person who is an estimation target at that time is linked as correct answer data. In the example of FIG. 6, the feature data is generated at intervals of 1 second. The estimation model can be generated by applying feature data that includes correct answer data of a certain level or more as training data to a machine learning algorithm such as a random forest. Since a method of generating an estimation model is publicly known and is not a main requirement of the present invention, a detailed description thereof will be omitted. In the present embodiment, for the features 602 to 607, data obtained by calculating each feature value from a position where the portable terminal 5 was actually positioned at each time, an orientation in which the portable terminal 5 was actually oriented, and an actual operation log of each machine are used as training data. Further, in the present embodiment, the features 608 to 611 relating to the plan are generated by using the information of a plan generated in advance in the procedure described with reference to FIG. 7 and FIGS. 8A, 8B, and 8C. The plan generated in advance is a plan in which a common recognition is obtained in that, between the estimation target (for example, the worker 1) and the estimation apparatus 1, the estimation target works on the basis of the plan. That is, when the plan generation apparatus 10 generates, for example, one day's worth of a plan relating to an estimation target, it is possible to calculate one day's worth of a feature relating to the plan relating to the estimation target. Subsequently, even if the estimation target performs work after ignoring the plan generated by the estimation apparatus 1 due to some trouble, a feature relating to the plan which is already calculated is not changed. On the other hand, when the estimation apparatus 1 re-generates the plan relating to the estimation target for some reason, features relating to the plan after that time are calculated again by the method described above based on the newly generated plan.

Next, the accuracy of the generated estimation model will be described. The feature data with correct answer data that is not used at a time of training is input as test data to the above-described generated estimation model to cause estimation to be actually performed. The estimation accuracy of the estimation model can be obtained from an estimation result estimated by the estimation model and the correct answer data associated with the input feature data. There are several methods to represent estimation accuracy. For example, there is a reproducibility for expressing the estimation system by indicating how much an XYZ process can be correctly estimated from among data for which the correct answer is the XYZ process. In addition, there is a suitability rate for expressing the estimation accuracy by indicating how many of the results estimated by the estimation model to be the XYZ process are actually the XYZ process.

Next, a description will be given of processing for a case of actually estimating using the generated estimation model. In actual estimation, the feature data of the columns 602 to 607 for the time of a target of estimation and the feature data related to the plans for the columns 608 to 611 for this time are input to the estimation model, and an estimation result is obtained. At this time, when the progress information accepting unit 104 has not received information such as a delay in the progress of the estimation target (information that work is not proceeding as planned), the feature data relating to the plan is generated based on the latest plan that is generated in advance by the plan generation apparatus 10. However, when the progress information accepting unit 104 receives information such as the progress of the estimation target has been delayed, features related to the plan are generated according to the importance/urgency of the process in which the delay or the like has occurred. The estimation model performs estimation by taking the re-generated feature data as input data. Hereinafter, detailed processing related to the generation of features related to the plan will be described.

Hereinafter, details of how features relating to the plan which are used for estimation by the estimation model are re-generated will be described with reference to FIGS. 9A and 9B, FIGS. 10A and 10B, and FIGS. 11A, 11B, and 11C.

FIGS. 9A and 9B illustrate processing flow of the calculation method decision unit 106. The calculation method decision unit 106 decides a method of calculating a feature related to the plan, and the feature generation unit 107 generates the feature related to the plan based on the decided calculation method. Since the specific value of the feature relating to the plan is calculated based on the distributions such as the distributions 711 to 744 as described above, the generation of the distributions is the role of the calculation method decision unit 106. Note that, in the present embodiment, it is assumed that the processing flow illustrated in FIGS. 9A and 9B starts at the same time as a worker (estimation target) starts work. Further, in the present embodiment, a procedure in the case where a plan is delayed in the middle of work is taken as a representative example, and a procedure of how a feature related to the plan is generated again is illustrated. The concept illustrated in FIGS. 9A and 9B is also applicable to other cases, such as when work is ahead of plan. Consideration for other cases will be separately described later.

In step S601, the calculation method decision unit 106 generates a distribution to be applied based on a prior plan generated by the plan generation apparatus 10. This step is executed when the plan generation apparatus 10 has first generated a plan to be followed by the worker who is the estimation target, or when the plan generation apparatus 1 has re-planned while the worker is working. A specific procedure for generating the distribution in this step is as described with reference to FIG. 7 and FIGS. 8A, 8B, and 8C.

In step S602, the calculation method decision unit 106 determines whether the plan generation apparatus 10 has re-generated the plan. More specifically, the content of the table 420 of the estimated/actual management unit 102 when this step was last performed is compared with the table 420 when this step is performed this time, and it is determined whether or not there is a difference in the location of the plan information. If the plan has been re-generated, the processing transitions to step S601. If it has not been regenerated, the processing transitions to step S603.

In step S603, the calculation method decision unit 106 acquires the progress from the progress information accepting unit 104. When a user of the process estimation apparatus 1 inputs information on work progress with respect to the plan, the progress information accepting unit 104 stores the information in the primary storage apparatus 14. Then, the progress information accepting unit 104 presents the latest progress information to be held in response to a request from the calculation method decision unit 106. Since when the information on the work progress is updated depends on the user who uses the process estimation apparatus 1, even if the work is delayed, such information is not always provided to the calculation method decision unit 106. The progress information is configured by “progress status” and “progress value”. Types of progress status include “as planned,” “delayed”, and “ahead of schedule”. “As planned” is a status indicating that the process planned at the current time is being performed as scheduled. “Delayed” is a status indicating that the work is delayed and the process scheduled for the current time has not yet been performed. “Ahead of schedule” is a status indicating that the process planned at the current time has been started ahead of the plan. The progress value is a value for expressing the degree of the progress status, and is expressed, for example, in units of minutes. For example, when the status of the progress is “delayed” and the progress value is 10, it indicates that the previous plan is delayed by 10 minutes and the start time of a process originally scheduled to be performed at the current time is delayed by 10 minutes according to calculations.

In the present embodiment, a user explicitly inputs progress information, but progress information may be provided to the progress information accepting unit 104 by another method in actual operation. For example, the progress information may be calculated from the operation logs of the machines 2 to 4 that are acquired by the machine operation log acquisition unit. Despite the fact that a printing process for an order was planned to start from 10:00, it is assumed that the fact that the printing for the order started from 9:45 was described in the log output by the printing machine 1. In this case, it is possible to generate progress information indicating that the printing process started 15 minutes ahead of schedule. When there is the appearance of a case in which, from the information on the estimation accuracy of the estimation model, an estimation result is sufficiently reliable (for example, the estimation accuracy is equal to or greater than a predetermined value), the progress information may be generated from this information. For example, when the accuracy of estimating the bookbinding process is high in both reproducibility and suitability, and when the estimation model estimates that the bookbinding process is being performed, this information can be handled as reliable information. If it is estimated that the bookbinding process was performed at 9:50 with respect to a plan where the bookbinding process was scheduled to be from 10:00, it is possible to generate progress information indicating that the bookbinding process has been performed 15 minutes in advance.

In step S604, it is determined whether the status of the progress has changed from “delayed” to “as planned”. If the status changes from “delayed” to “as planned”, the processing transitions to step S601. Otherwise, the processing transitions to step S605.

In step S605, the calculation method decision unit 106 determines whether or not the status of the progress has changed from “as planned” to “delayed”. If it has changed from “as planned” to “delayed”, the processing transitions to step S606. Otherwise, the processing transitions to step S614.

In step S606, the calculation method decision unit 106 acquires the importance/urgency of the processes planned after the current time in the prior plan, which are decided by the importance/urgency decision unit 105. In the present embodiment, it is determined whether or not the importance/urgency of each process is high, based on whether or not the process is included in a critical path. A critical path is a sequence of processes that effectively decide a plan for all work at a printing site. Delays in the process on the critical path result in delays in the final work completion time of the entire printing site. Therefore, it is considered that a processes on the critical path has a high importance/urgency. In the present embodiment, the importance/urgency of a process included in the critical path is set to be high, and the importance/urgency of a process not included are set to be low. In actual operation, the importance/urgency may be decided by another method.

For example, in consideration of the delivery deadline of printed matter, the importance/urgency may be set high in the case where the process is on the critical path for the entire plan and the delivery deadline of the printed matter will not be met if the process is delayed. The delivery deadline information can be specified by referring to the column 417 of the table 410. Alternatively, instead of the delivery deadline, the importance/urgency may be decided based on whether the process is on the critical path of a plan, and whether printed matter generated by the process is an express order. Whether this is for an express order can be specified by referring to the column 314 of the table 310.

In step S607, the calculation method decision unit 106 determines whether or not each process is included in the critical path. If the process is included in the critical path, the processing transitions to step S610. If the process is not included in the critical path, the processing transitions to step S608.

In step S608, the calculation method decision unit 106 simulates a situation for if the work were continued in accordance with the work time periods of the processes planned in the prior plan.

In step S609, the calculation method decision unit 106 determines whether or not the result of performing the simulation in step S608 is that a delayed process would consequently be included in the critical path. If a delayed process would be included in the critical path, the processing transitions to step S610. If a delayed process would not be included in the critical path, the processing proceeds to step S612.

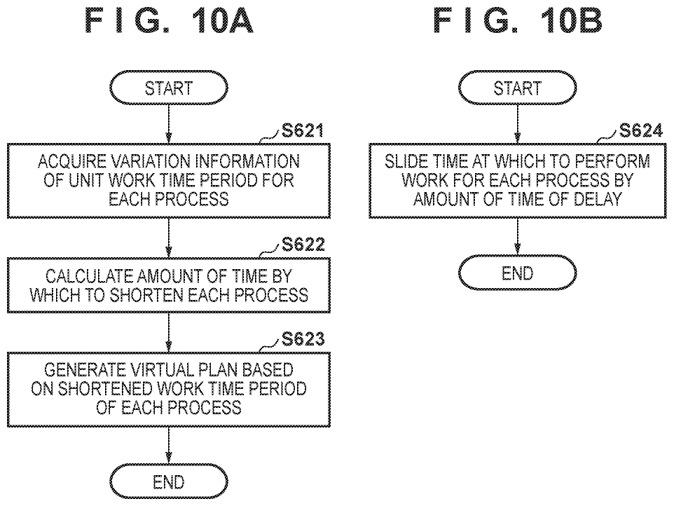

In step S610, the calculation method decision unit 106 generates a virtual plan for the processes included in the critical path. A virtual plan (hereinafter also referred to as a virtual plan) is a plan that an estimation target is likely to follow when they perform work. A virtual plan may differ from a plan that is generated in advance. Details of the processing of this step will be described later with reference to FIG. 10A.

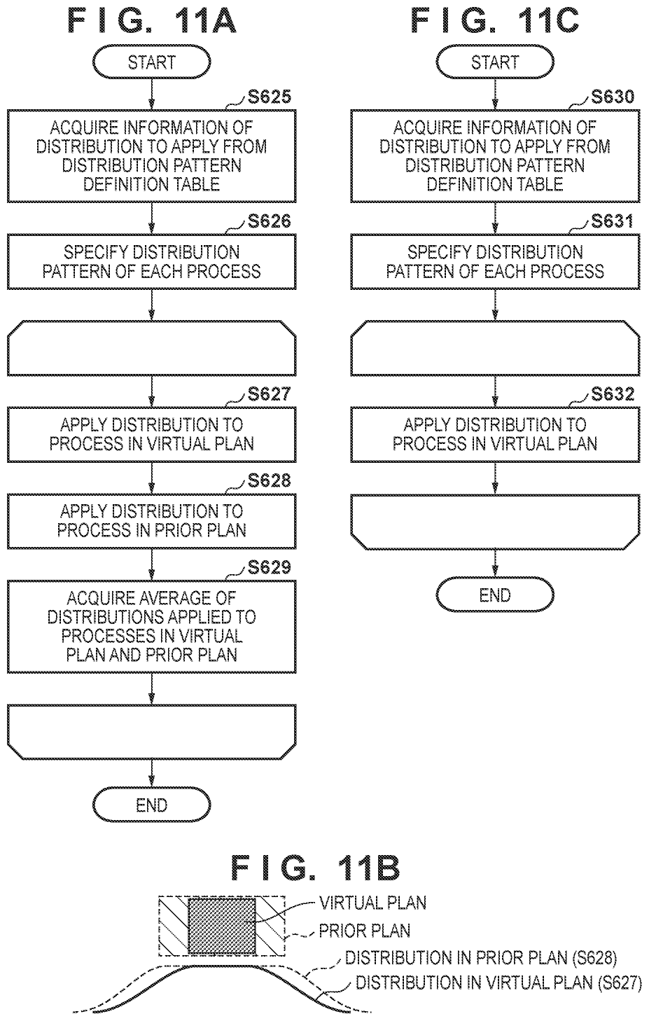

In step S611, the calculation method decision unit 106 generates distributions by deciding the distribution to apply to each process included in the critical path. Details of the processing of this step will be described later with reference to FIG. 11A and FIG. 11B.

In step S612, the calculation method decision unit 106 generates a virtual plan for the processes not included in the critical path. Details of the processing of this step will be described later with reference to FIG. 10B.

In step S613, the calculation method decision unit 106 generates distributions by deciding the distribution to apply to each process not included in the critical path. Details of this step will be described later with reference to FIG. 11C.

In step S614, the calculation method decision unit 106 determines whether process estimation by the process estimation unit 114 has ended. Whether or not the process estimation has ended is determined based on whether or not the estimation target is present at the printing site, based on the position information of the portable information terminal 5 held by the worker who is the estimation target. In the present embodiment, it is assumed that the process estimation has ended when the worker as the estimation target has left the printing site. It should be noted that the determination may be made by other methods. For example, the user of the process estimation apparatus 1 may explicitly instruct the end of the process estimation processing via the input device 11. When this ends, the processing flow illustrated in FIGS. 9A and 9B ends. If the process estimation continues, the processing transitions to step S615.

In step S615, the calculation method decision unit 106 stops the processing and waits for a predetermined period of time (for example, one second), and then transitions to step S602.

The processing of step S610 to step S613 in FIG. 9B will be described in detail with reference to FIGS. 10A and 10B and FIGS. 11A, 11B, and 11C.

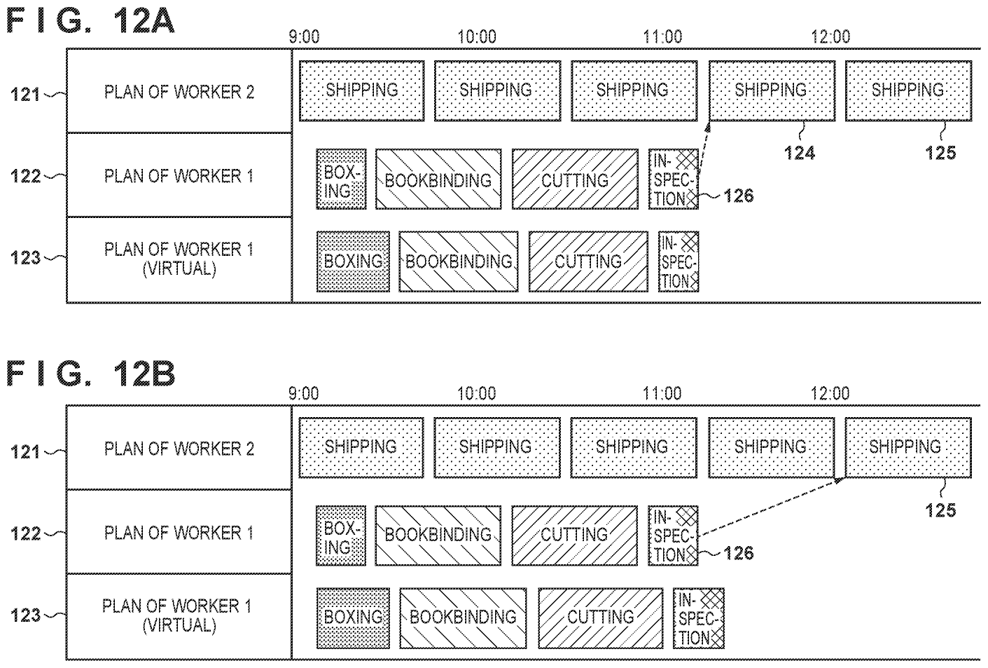

FIG. 10A illustrates a detailed processing flow of step S610. FIG. 10A is a processing flow in the case where a process after the current time is included in the critical path, and the situation illustrated in FIG. 12A will be described as an example. A row 121 of FIG. 12A describes the prior work plan of a worker 2. The worker 2 is scheduled to ship printed matter produced by another worker from 9:00 to after 12:00. A row 122 describes a prior plan of the worker 1 who is an estimation target. The worker 1 generates printed matter between 9 and 11 by performing a boxing process, a bookbinding process, a cutting process, and an inspection process. The printed matter inspected by the worker 1 in an inspection process 126 is scheduled to be shipped by the worker 2 in a shipping process 124. In FIG. 12A, the work of the worker 1 and the shipping process 124 and a shipping process 125 of the worker 2 are a critical path of this day at the printing site. A virtual plan for the worker 1 is illustrated in a row 123. The virtual plan is described in detail below.

In step S621, the calculation method decision unit 106 acquires variation information of the unit work time periods of the respective processes. Specifically, the value of the standard deviation with respect to the unit work time period of a process is acquired with reference to the information stored in the column 327 of the process table 320. A process for which variation information is acquired is a process after the current time in the row 122 which configures the prior plan of the worker 1 who is the estimation target.

In step S622, the calculation method decision unit 106 calculates an amount of time by which to shorten each process. Based on the standard deviation of each process acquired in step S621, it is decided by how much the work of each process should be shortened. In the present embodiment, it is considered that the smaller the value of the ratio (unit work time period÷standard deviation), the easier it is to make the work time period shorter than the planned time when executing the process. That is, when a delay occurs, the amount of time by which to shorten each process is calculated for the processes included in the critical path of the worker 1 after the current time. The amount of time by which to shorten each process is calculated by solving an equation obtained from the above-mentioned ratio of each process, the length of the work time period of each process in the prior plan, and the sum total of the amount of time that must be shortened among all processes. Note that the total amount of time that must be shortened across all the processes is an amount of time indicated by the progress value acquired from the progress information accepting unit 104.

The row 123 of FIG. 12A is a virtual plan generated by shortening each work time period of the bookbinding process, the cutting process, and the inspection process in the case where a delay occurs in the boxing process by the method described above. The example of FIG. 12A illustrates an example of a case in which the standard deviation of the bookbinding process and the cutting process is almost 0 and the standard deviation of the inspection process is large. That is, by preferentially shortening the work time period of the inspection process 126, it is possible to suppress influence on the work start time of the shipping process 124. In actual operation, the virtual plan may be calculated by a method other than that described above. For example, shortening may be performed so that the amount of time to shorten for each unit work time period is uniformly equal for all shortened processes.

In step S623, the calculation method decision unit 106 generates a virtual plan based on the shortened work time period of each process.

FIG. 11A illustrates a detailed processing flow of step S611.

In step S625, the calculation method decision unit 106 acquires information of the distribution pattern definition table 800.

In step S626, the calculation method decision unit 106 acquires the distribution base and parameters of the respective processes from the column 803 and the column 804 of the table 800.

Hereinafter, step S627 to step S629 are performed for each process in the virtual plan.

In step S627, with respect to the process in the virtual plan, the calculation method decision unit 106 generates a distribution based on the distribution pattern of the process which was specified in step S626.

In step S628, with respect to the process in the prior plan, the calculation method decision unit 106 generates a distribution based on the distribution pattern of the process which was specified in step S626.

In step S629, the calculation method decision unit 106 generates a distribution having two average features from the two distributions that relate to the process and were generated in step S627 and step S628.

Supplemental description for step S629 will be given with reference to FIG. 11B. In FIG. 11B, a box is illustrated illustrating the length of a work time period for a process planned in the prior plan. In addition, a distribution generated for a box for the prior plan described above is illustrated. In addition, a distribution generated for a box for the virtual plan is illustrated. The distributions of the prior plan and the virtual plan are arranged so that the center positions of the distributions coincide with each other, and accordingly, the two distributions are also arranged so that the center positions coincide with each other. Here, the final distribution generated in step S629 is a distribution that passes through the middle of the two distributions illustrated in FIG. 11B. That is, the height of the possibility of the process at each time is an average value of the height of the distribution in the prior plan and the height of the distribution in the virtual plan.

According to the method described above, when a distribution is generated for a virtual plan, it is possible to generate a distribution in which a deviation of the plan is allowed more than when generating by the method described in FIG. 7 and FIGS. 8A, 8B, and 8C.

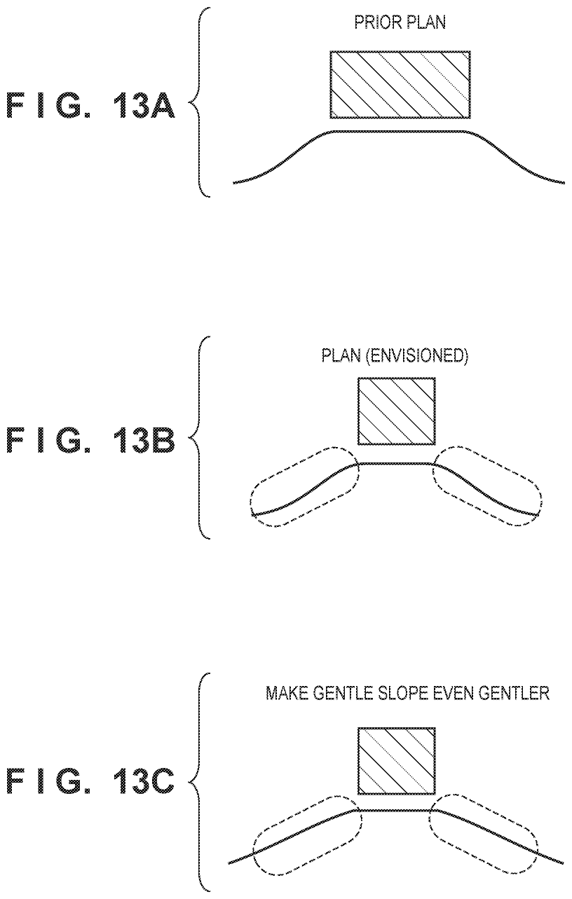

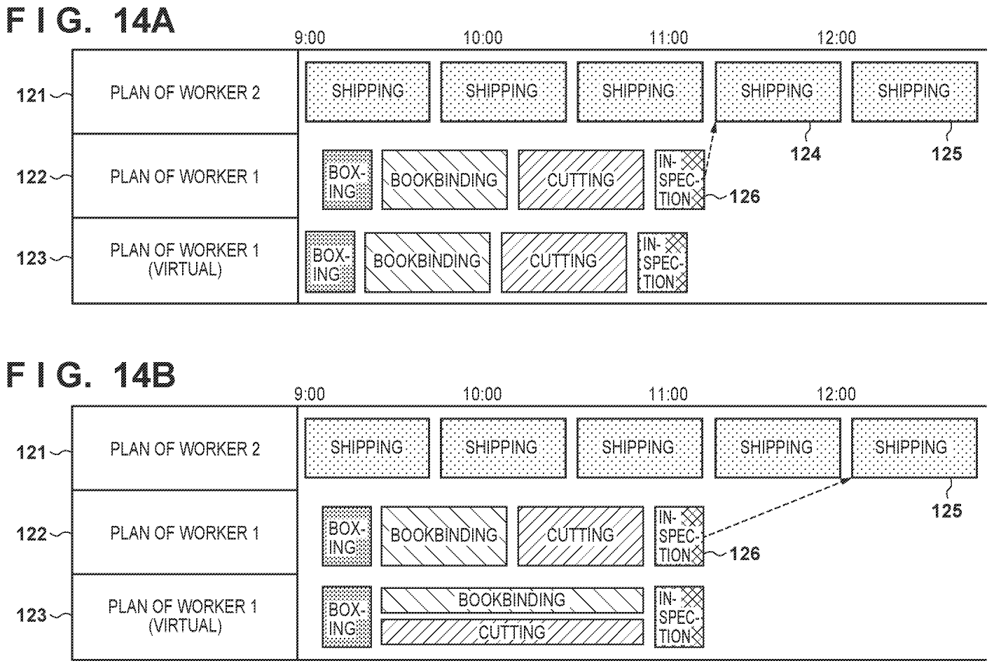

Note that, in actual operation, a method of generating a distribution that allows deviation in a plan is not limited to that illustrated in FIG. 11B. Another example is a method described by FIGS. 13A, 13B, and 13C. FIG. 13A illustrates a distribution generated for a prior plan, and FIG. 13B illustrates a distribution for a virtual plan in which the prior plan is shortened. Both are distributions generated by the method described by FIG. 7 and FIGS. 8A, 8B, and 8C. In contrast, FIG. 13C is a distribution generated by, when generating the tail portion of the distribution of FIG. 13B, increasing the value of the standard deviation of the tail which is set in the column 804. As a result, FIG. 13C can realize a design of a feature that more likely to absorb the effect when the work does not proceed as planned than FIG. 13B. When a distribution is generated for a virtual plan, a rule that the standard deviation of the tail is, based on a predetermined arrangement, made larger than that defined in the table 800 is set, so that a distribution that allows deviation of the plan can be generated.

FIG. 10B illustrates a detailed processing flow of step S612. FIG. 10B is a processing flow in the case where a process which is a target for generating a virtual plan is not included in the critical path, and the situation illustrated in FIG. 12B will be described as an example. Similarly to FIG. 12A, rows 121 and 122 of FIG. 12B describe prior work plans of the worker 2 and the worker 1 who is the estimation target. The schedule of the process performed by each worker is similar to the case of FIG. 12A, but in FIG. 12B, the printed matter inspected by the worker 1 in the inspection process 126 is scheduled to be shipped by the worker 2 in the shipping process 125. Note that, in FIG. 12B, the work of the worker 1 is not in a critical path. A virtual plan for the worker 1 is illustrated in row 123. The virtual plan is described in detail below.

In step S624, the calculation method decision unit 106 slides the times for performing the work of each process in the direction of travel of time by the amount of time of the delay. Row 123 of FIG. 12B illustrates a virtual plan for a case where the boxing process is prolonged (a delay is occurring) with respect to the prior plan. In the row 123, a virtual plan of a bookbinding process, a cutting process, and an inspection process is placed after the prolonged boxing process, in a state where respective work time periods stay as long as those in the row 122. As can be seen from the figure, even if the worker 1 continues work according to the virtual plan that was generated, there is no influence on the critical path at the printing site.

FIG. 11C illustrates a detailed processing flow of step S613.

In step S630, the calculation method decision unit 106 acquires information of the distribution pattern definition table 800.

In step S631, the calculation method decision unit 106 acquires the distribution base and parameters of the respective processes from the column 803 and the column 804 of the table 800.

Hereinafter, step S632 is performed for each process in the virtual plan.

In step S632, with respect to the process in the virtual plan, the calculation method decision unit 106 generates a distribution for the process which was specified in step S631. The method of generating the distribution is according to the procedure described with reference to FIGS. 13A, 13B, and 13C. In other words, there is a distribution where the influence of the tail extends over a wider range than a distribution generated by the procedure described with reference to FIG. 7 and FIGS. 8A, 8B, and 8C, and it is possible to generate a distribution that is more likely to tolerate deviation from the virtual plan.

In the present embodiment, description was given for processing of the calculation method decision unit 106 by taking as an example a case where the progress of work is delayed. However, based on the concept described in the present embodiment, it is possible to provide an appropriate method of calculating a feature related to the plan even in a case where the progress of the work is otherwise. Hereinafter, some examples other than the case where the work progress is delayed will be described with reference to FIGS. 14A and 14B.

FIG. 14A illustrates what kind of virtual plan is generated when work progresses ahead of a prior plan. The contents of rows 121 and 122 in FIG. 14A are the same as those in FIG. 12A. In row 123 in FIG. 14A, the boxing process has started earlier than the prior plan. In this case, the start position of the process in the virtual plan is planned so that the start times are uniformly advanced by an amount of time by which the boxing was early. The method of generating the distribution at this time has similar details as those described with reference to FIG. 12B.

FIG. 14B illustrates an example of what kind of virtual plan is generated when work is proceeding in an order different from the order scheduled in the prior plan. Specifically, if the cutting process is to be performed after the bookbinding process is performed in the prior plan, there are cases where the bookbinding process and the cutting process are performed simultaneously in parallel. The contents of rows 121 and 122 in FIG. 14B are the same as those in FIG. 12B. The row 123 in FIG. 14B reflects the fact that the bookbinding process and the automatic cutting process are performed in parallel concurrently, and the bookbinding and automatic cutting processes are scheduled at the same time. Further, since the bookbinding process and the cutting process are performed simultaneously, the length of the work time period of both processes is the total of the work time periods in the prior plan. The method of generating the distribution at this time is similar to the case described with reference to FIG. 12B.

By virtue of the technique described above, it is possible to appropriately generate a feature related to a plan used in process estimation by machine learning without re-planning even in a situation where work is not proceeding as planned in advance.

### Second Embodiment

Description is given for an example of a second embodiment of the present invention. In the present embodiment, an example of generating the above-mentioned virtual plan and distribution based on past actual results will be described.

In the first embodiment, the method of generating a virtual plan is uniquely decided in accordance with the status of the progress and the importance/urgency. Actually, however, when a process included in a critical path is delayed, it is not necessarily the case that work is performed each time by shortening the work time period of each process. In some cases, work is performed by shortening the work time period so as not to affect the entire plan, and in other cases, the work is continued with the work time period allocated in the prior plan without worrying about the delay.

In the first embodiment, the distribution generated for each process is generated based on a specific distribution pattern decided from the process ID. However, there may be other optimal distribution patterns in a specific situation.

In the present embodiment, description is given for an example of a method of generating a virtual plan and a distribution optimized for each worker based on knowledge obtained by analyzing the tendency of each worker from actual results from the past.

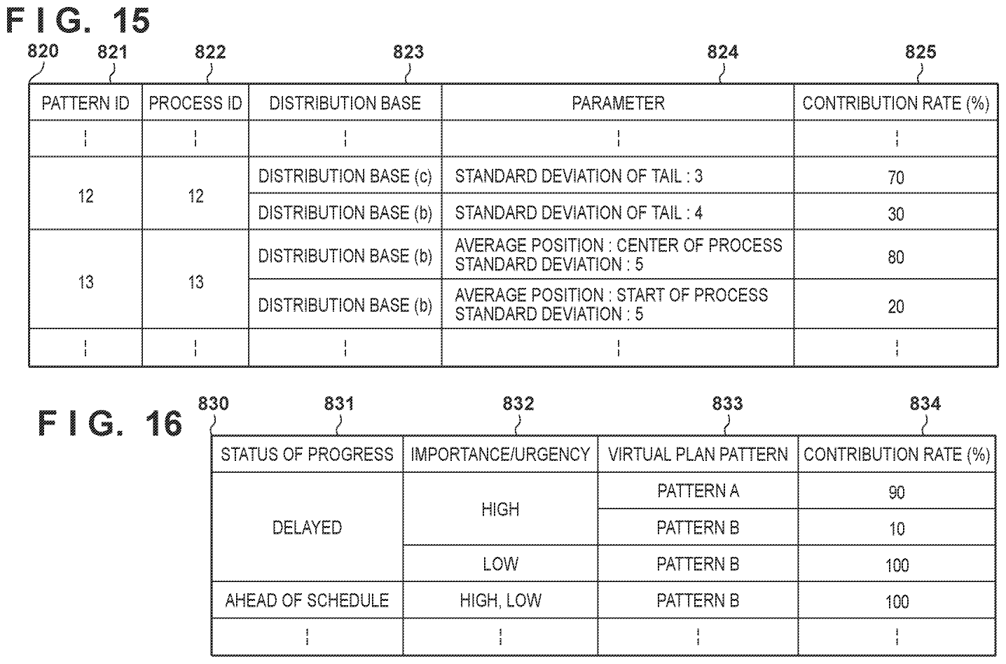

FIG. 15 illustrates a distribution pattern definition table according to the present embodiment. The distribution pattern definition table in this embodiment is generated for each worker. A table 820 is a distribution pattern definition table for the worker 1. The contents of the columns 821 to 824 are similar to those of the columns 800 to 804. However, in the table 820, a plurality of distribution bases and parameters may be associated with one process ID. A column 825 illustrates the contribution rate of each distribution base/parameter.

When generating a distribution for each process, each distribution base/parameter associated with the process is used to generate a distribution in the manner described in the first embodiment. For a process for which there are a plurality of distribution bases/parameters, a distribution is generated by combining distributions based on the contribution rate of each distribution. Note that the contribution rate is a value (a statistic) statistically calculated from past actual result information.

FIG. 16 illustrates a virtual plan pattern definition table. The virtual plan pattern definition table is generated for each worker. A virtual plan pattern definition table 830 illustrated in FIG. 16 is a table related to the worker 1. A column 831 stores the status of the progress. A column 832 stores the magnitude of the importance/urgency. A column 833 stores virtual plan patterns. Note that a pattern “same as the prior plan” may be provided as one of the virtual plan patterns stored in the column 833. A column 834 stores contribution rates of virtual plan patterns. Note that the contribution rate is a value statistically calculated from past actual result information.

When a virtual plan is generated, the virtual plan is generated by a virtual plan pattern linked to the corresponding progress status and the level of the importance/urgency. Note that, when a plurality of virtual plan patterns are linked, individual virtual plans are generated independently. With respect to the generated virtual plan, the distribution is generated by referring to the table 820 illustrated in FIG. 15. Thereafter, the distributions respectively generated for the plurality of virtual plans are combined based on the contribution rates described in the column 825, thereby generating a final distribution.

### Third Embodiment

Description is given for an example of a third embodiment of the present invention. In the present embodiment, the process estimation apparatus 1 displays a screen that enables a user to grasp (or is capable of allowing a user to grasp) a prior work plan, an estimation result (actual results for the plan), the virtual plan described above, and information on a distribution used for the generation of a feature related to the plan. According to the present embodiment, it is possible to externally verify whether or not a distribution is changed at a time of estimation.

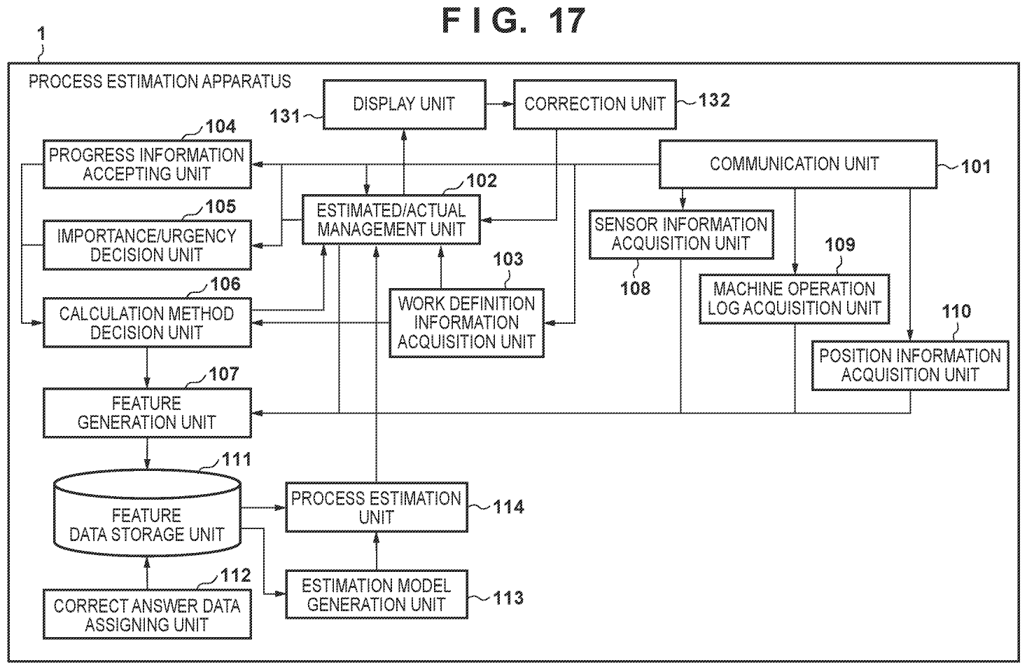

FIG. 17 illustrates a functional block diagram for explaining main functions of the process estimation apparatus 1 according to the present embodiment. In the functional block diagram illustrated in FIG. 17, a display unit 131 and a correction unit 132 are illustrated in addition to the functional blocks illustrated in FIG. 5.

The display unit 131 displays information relating to a work plan generated in advance and actual result information linked thereto that are managed by the estimated/actual management unit 102. The work plan is a work schedule for the estimation target at each time, and is information described in the table 420. The actual result information is the type of the process, estimated by the process estimation unit 114, for which the estimation target is working on at each time. The display unit 131 can also display the virtual plan used at the time of estimation, and the distribution generated based on the prior work plan and the virtual plan. Note that the function of the display unit 131 is realized by the output device 12 included in the process estimation apparatus 1.

The correction unit 132 provides a function for a user to explicitly correct an estimation result and an envisioned plan after the estimation. The estimation result in accordance with the process estimation unit 114 includes an error corresponding to the estimation accuracy of the estimator. When a user is able find a result that was erroneously estimated, by correcting the result to a correct result, the result can be reused for a purpose such as training data for an estimation model. With regard to the envisioned plan, if it is possible to record whether it is envisioned how the worker who is the estimation target will perform work as correct answer data for the envisioned plan, it is possible to use this when generating an envisioned plan thereafter. In other words, it is possible to improve the accuracy of a result of generating an envisioned plan.

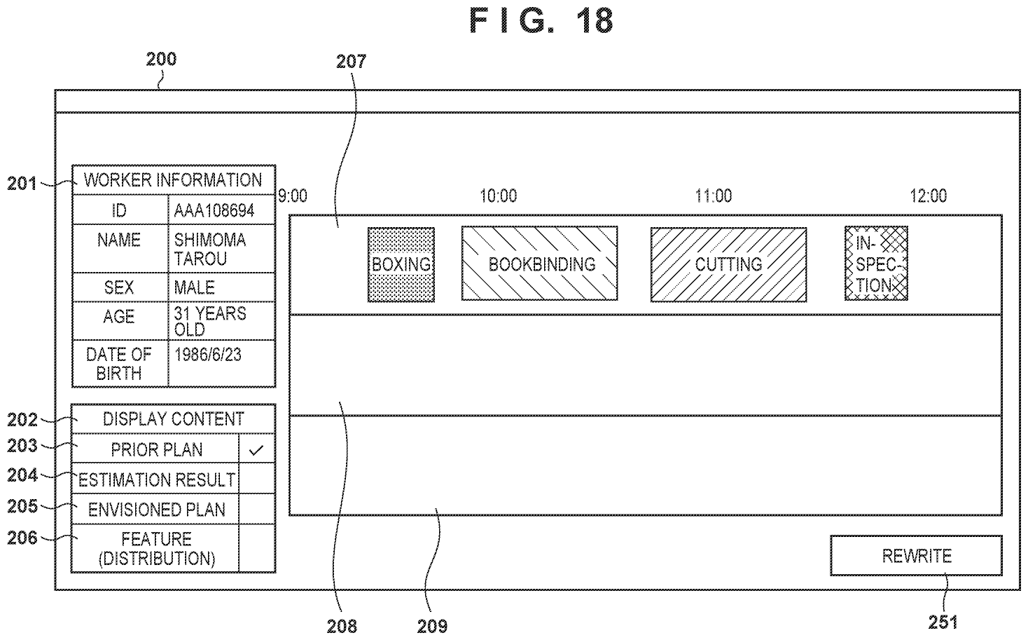

FIGS. 18 to 22 illustrate examples of screens displayed by the display unit 131. An example of an operation for performing a correction by the correction unit 132 will be described with the screens illustrated in FIGS. 18 to 22.

FIG. 18 illustrates a management screen 200 displayed by the display unit 131. The management screen 200 is provided with a worker information display area 201, a display content selection area 202, a prior plan display area 207, an estimation result display area 208, and an envisioned plan display area 209. A rewrite button 251 is placed on the management screen 200.

In the worker information display area 201, information of an estimation target of the process estimation unit 114, which is a target of information display by the management screen 200, is displayed.

In the display content selection area 202, check boxes 203 to 206 for specifying what information to display on the management screen 200 are arranged. When the check box 203 is checked, information on a prior plan is displayed. When the check box 204 is checked, information on an estimation result is displayed. When the check box 205 is checked, information on a virtual plan is displayed. When the check box 206 is checked, information on distributions used when calculating the feature related to the plan is displayed.

In the prior plan display area 207, when the prior plan display check box 203 is checked, the work schedule of the estimation target, which is described in the worker information, is displayed. The displayed work schedule is a plan that is generated in advance by the plan generation apparatus 10. In the example of FIG. 18, the type of the process for which work is scheduled at each time is displayed. It should be noted that information for enabling the identification of which order a process corresponds to may be displayed also.

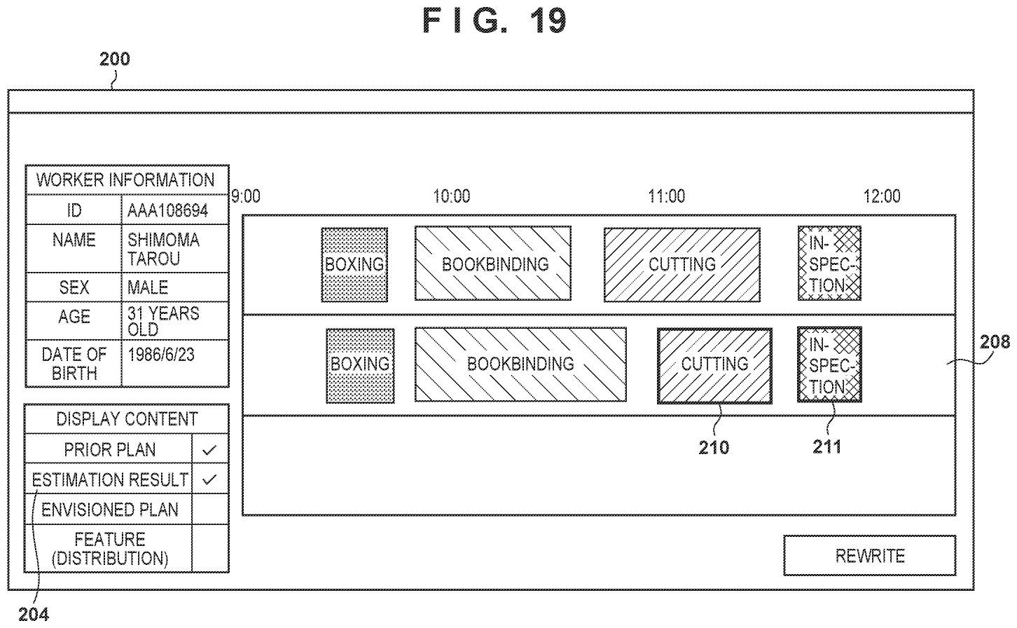

FIG. 19 illustrates the display content of the management screen 200 when the estimation result display check box 204 is checked. In the estimation result display area 208 in FIG. 19, the type of the work process at each time is displayed as actual result information. This information is an estimation result estimated by the process estimation unit 114. Here, an estimation result 210 and an estimation result 211 are highlighted by a thick frame. This indicates a process estimated using a feature relating to a plan generated by changing the calculation method after the occurrence, for example, of a delay with respect to a work plan. It should be noted that there is no limitation to display by a thick frame, and highlighting may be performed by another method such as display in a color different from that of other portions at the time of display. In addition, configuration may be taken to, instead of displaying all the boxes indicating processes by thick frames, highlight only a part of a box indicating a process. That is, configuration may be taken to, when the calculation method is changed partway through with respect to a box for a cutting process which is highlighted, surround the cutting process from only point in time of the change by a thick frame.

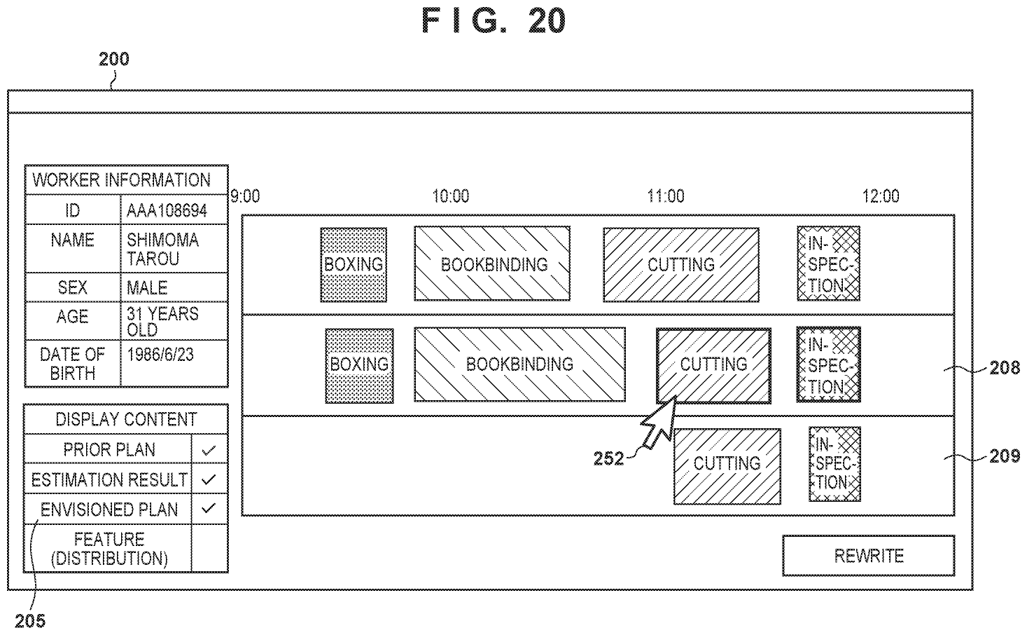

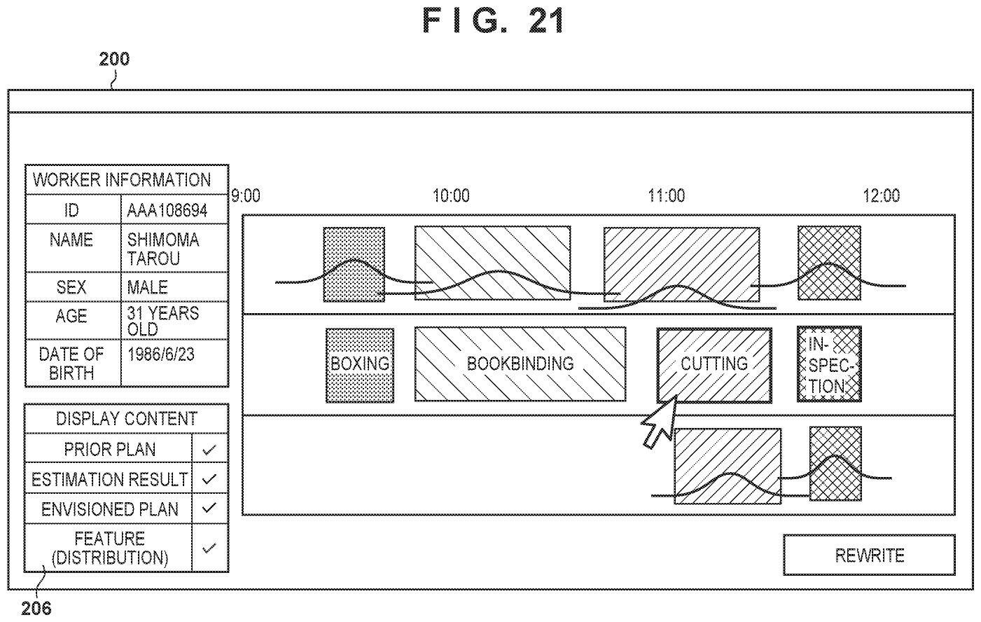

FIG. 20 illustrates the display content of the management screen 200 when the virtual plan display check box 205 is checked. When the display check box 205 of the virtual plan is checked, it is possible to make an instruction for an arbitrary point in time of the estimation result highlighted with the pointer 212 to thereby expand or contract the unit work time period and display the virtual plan that is re-generated virtually in the virtual plan display area 209. FIG. 20 illustrates an example of a case of pointing at a location for 11:00 with respect to a box indicating that cutting is estimated, which is displayed in the estimation result display area 208. When the process estimation unit 114 performs estimation for the process that the worker will perform at 11:00 instructed by the pointer, the virtual plan generated by the calculation method decision unit 106 is displayed in the virtual plan display area 209. As described in the second embodiment, when a plurality of types of virtual plans are generated and features related to the final plan are calculated, the virtual plans are displayed in order in the virtual plan display area 209. In the example of FIG. 20, only the virtual plan after the time that is pointed at is displayed, but the range to be displayed may be decided according to another rule.

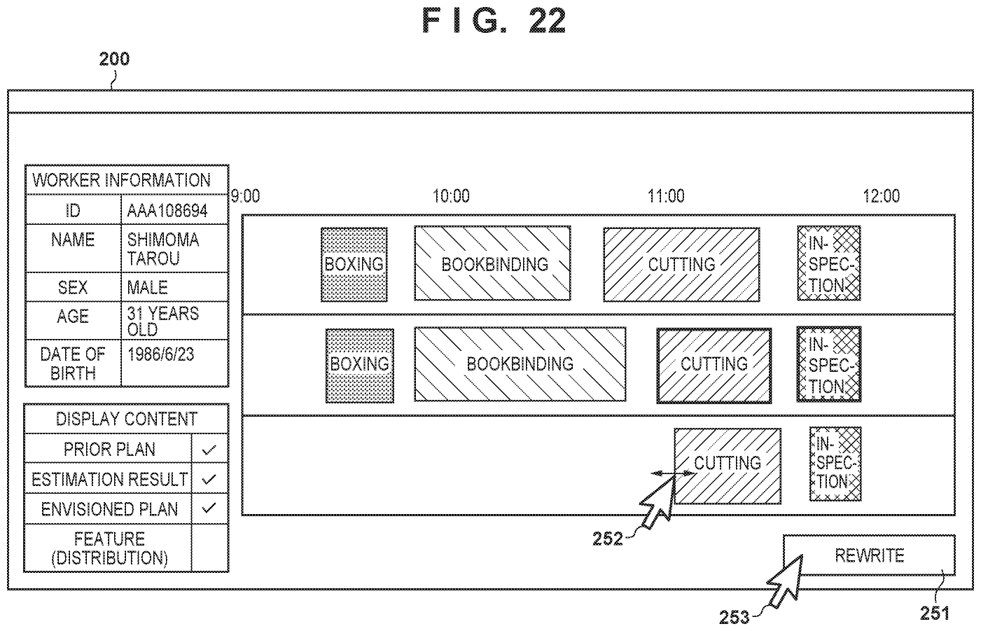

FIG. 21 illustrates the display content of the management screen 200 when the distribution display check box 206 is checked. In the example of FIG. 21, in addition to the display contents relating to the prior plan and the virtual plan described with reference to FIGS. 19 and 20, distributions that are generated based on these plans and used when calculating the features relating to the plan are superimposed and displayed. By providing such a display to a user, it is possible to support design regarding features for machine learning.

FIG. 22 illustrates a procedure of an operation for performing correction by the correction unit 132. The pointer 252 performs an operation of advancing or retarding the start position of a cutting process of a virtual plan. This operation can be realized, for example, by specifying the left end of the box of the process with a pointer and dragging it left or right. Thereafter, by clicking the rewrite button 251 with the pointer 253, the corrected content is recorded in the estimated/actual management unit 102.

In the present embodiment, description has been given for an example of displaying on a screen information as to whether or not a method of calculating a feature relating to the plan used at the time of estimation has changed. Note that display may be performed by another method as long as the format of the display is easy for the user to identify. For example, when the estimated/actual management unit 102 uses a relational DB to record the estimation result, a column (column) indicating whether or not the distribution is changed may be provided in a table for storing estimation results. That is, DB design may be performed so that a user can grasp which distribution pattern was used at the time of estimation by looking at the table or in accordance with an SQL (Structured Query Language) operation by the user.

### Other Embodiments

Although embodiments have been described above in detail, it is possible to have an embodiment of the present invention as, for example, a system, an apparatus, a method, a program, a recording medium (a storage medium), or the like. Specifically, the present invention may be applied to a system configured from a plurality of devices (for example, a host computer, an interface devices, an imaging apparatus, a web application, and the like), or may be applied to an apparatus that includes a single device.

It is needless to say that the object of the present invention is achieved by the following steps. That is, a recording medium (or a storage medium) on which program code (computer program) of software for realizing the functions of the above-described embodiments is recorded is supplied to a system or an apparatus. Such a storage medium is, of course, a computer-readable storage medium. Then, a computer (or a CPU or an MPU (Micro Processing Unit)) of the system or apparatus reads out and executes the program code stored in the recording medium. In this case, the program code itself read out from the recording medium realizes the functions of the above-described embodiments, and the recording medium on which the program code is recorded constitutes the present invention.

Embodiment(s) of the present invention can also be realized by a computer of a system or apparatus that reads out and executes computer executable instructions (e.g., one or more programs) recorded on a storage medium (which may also be referred to more fully as ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-235905, filed Dec. 17, 2018, which is hereby incorporated by reference herein in its entirety.

What is claimed is:

1. A process estimation apparatus operable to, by machine learning using information regarding a plan as one of features, estimate a process being performed by a worker, the apparatus comprising:
a progress information accepting unit configured to accept progress information of each process configuring a plan that is generated in advance;
an importance/urgency decision unit configured to decide an importance/urgency of each process that configures the plan that is generated in advance; and
a calculation method decision unit configured to decide a method of calculating a feature related to a plan in accordance with the progress information accepted by the progress information accepting unit and the importance/urgency decided by the importance/urgency decision unit.

2. The process estimation apparatus according to claim 1, wherein
the feature that relates to the plan is expressed by a magnitude of a possibility of each estimation candidate process being a correct answer, which is calculated based on plan information,
the magnitude of the possibility is decided from any type of a distribution over a time axis, and
the calculation method decision unit decides the distribution in accordance with the progress information and the importance/urgency.

3. The process estimation apparatus according to claim 1, wherein
the importance/urgency decision unit determines whether each process configuring the plan is included in a critical path in a prior plan, and decides the importance/urgency of each process in accordance with a result of the determination.

4. The process estimation apparatus according to claim 3, wherein
when progress is delayed, the importance/urgency decision unit determines that the importance/urgency is high when a delayed process is included in the critical path in the prior plan, and
when progress is delayed, the importance/urgency decision unit also determines that the importance/urgency is high when the delayed process is not included in the critical path in the prior plan but will enter the critical path when, in a delayed situation, work continues in line with a work time period planned in advance.

5. The process estimation apparatus according to claim 1, wherein
from an estimation result for which an estimation accuracy of the process estimation apparatus is equal to or greater than a predetermined value, the progress information accepting unit accepts, as the progress information, information relating to one or a combination of processes that are delayed, are ahead of schedule, or are being performed in a sequence different from planned, or are being simultaneously being performed in parallel.

6. The process estimation apparatus according to claim 1, further comprising:
a storage unit configured to store past actual result information,
wherein, in accordance with the progress information and the importance/urgency, the calculation method decision unit decides the method of calculating the feature related to the plan based on a statistic of actual result information stored by a storage unit.

7. The process estimation apparatus according to claim 1, wherein
the calculation method decision unit decides the method of calculating the feature related to the plan by reflecting that, when progress is delayed, a work time period of a process having a high importance/urgency may be shorter than previously scheduled.

8. The process estimation apparatus according to claim 1, further comprising:
a table configured to store information on an average and standard deviation of a unit work time period of each process used when generating a plan,
wherein, when progress is delayed, the calculation method decision unit decides the method of calculating the feature related to the plan by reflecting that a work time period of, among processes having a high importance/urgency, a process having a large standard deviation of the unit work time period may be shorter than previously scheduled.

9. The process estimation apparatus according to claim 1, further comprising:
a display unit configured to display at least one of the plan generated in advance and a work result of a worker for which estimation is performed by the process estimation apparatus,
wherein the display unit displays in a format that enables identification of which method of calculating decided by the calculation method decision unit has been used to generate a feature related to a plan generated in advance for each time.

10. The process estimation apparatus according to claim 9, wherein
if the calculation method decision unit decides to calculate a feature value based on a virtual plan generated virtually by expanding or contracting an envisioned unit work time period relating to at least some of processes that configure the plan generated in advance,
the display unit also displays a virtual plan, or displays the plan generated in advance in a format in which a difference from the virtual plan can be understood.

11. A process estimation method for, by machine learning using information regarding a plan as one of features, estimating a process being performed by a worker, the method comprising:
accepting progress information of each process configuring a plan that is generated in advance;
deciding an importance/urgency of each process that configures the plan that is generated in advance; and
deciding a method of calculating a feature related to a plan in accordance with the accepted progress information and the decided importance/urgency.

12. The process estimation method according to claim 11, wherein
the feature that relates to the plan is expressed by a magnitude of a possibility of each estimation candidate process being a correct answer, which is calculated based on plan information,
the magnitude of the possibility is decided from any type of a distribution over a time axis, and
the distribution is decided in accordance with the progress information and the importance/urgency.

13. The method according to claim 11, wherein
it is determined whether each process configuring the plan is included in a critical path in a prior plan, and decides the importance/urgency of each process in accordance with a result of the determination.

14. The process estimation method according to claim 13, wherein
when progress is delayed, it is determined that the importance/urgency is high when a delayed process is included in the critical path in the prior plan, and
when progress is delayed, it is also determined that the importance/urgency is high when the delayed process is not included in the critical path in the prior plan but will enter the critical path when, in a delayed situation, work continues in line with a work time period planned in advance.

15. The process estimation method according to claim 11, wherein
from an estimation result for which an estimation accuracy of the process estimation apparatus is equal to or greater than a predetermined value, information relating to one or a combination of processes that are delayed, are ahead of schedule, are being performed in a sequence different from planned, or for which work is being performed in parallel is accepted as the progress information.

16. The process estimation method according to claim 11, wherein, in accordance with the progress information and the importance/urgency, the method of calculating the feature related to the plan is decided based on a statistic of actual result information stored by a storage unit.

17. The process estimation method according to claim 11, wherein
the method of calculating the feature related to the plan is decided by reflecting that, when progress is delayed, a work time period of a process having a high importance/urgency may be shorter than previously scheduled.

18. The process estimation method according to claim 11, further comprising:
causing at least one of the plan generated in advance and a work result of a worker for which estimation is performed by the process estimation method to be displayed,
wherein display is performed in a format that enables identification of which decided method of calculating has been used to generate a feature related to a plan generated in advance for each time.

19. The process estimation method according to claim 18, wherein
if it is decided to calculate a feature value based on a virtual plan that is re-generated virtually by expanding or contracting an envisioned unit work time period relating to at least some of processes that configure the plan generated in advance,
the virtual plan is also caused to be displayed, or the plan generated in advance in a format in which a difference from the virtual plan can be understood is caused to be displayed.

20. A non-transitory computer-readable storage medium storing a computer program for causing a computer to execute a method,
the method for, by machine learning using information regarding a plan as one of features, estimating a process being performed by a worker, and
the method comprising:
accepting progress information of each process configuring a plan that is generated in advance;
deciding an importance/urgency of each process that configures the plan that is generated in advance; and
deciding a method of calculating a feature related to a plan in accordance with the accepted progress information and the decided importance/urgency.
